(19) United States
(12) Patent Application Publication
(10) Pub. No.: US 2026/0195802 A1
(43) Pub. Date: Jul. 9, 2026

(54) AUTOMATIC CUSTOMER ROUTING BASED ON ARTIFICIAL INTELLIGENCE

(71) Applicant: RadiusAI, Inc., Tempe, AZ (US)

(72) Inventors: Aykut Dengi, Tempe, AZ (US); Adam Hardy, Tempe, AZ (US)

(21) Appl. No.: 19/442,785

(22) Filed: Jan. 7, 2026

Related U.S. Application Data
(60) Provisional application No. 63/742,608, filed on Jan. 7, 2025.

(51) Int. Cl. G06Q 30/0601; G06F 40/284; G06F 40/40; G06Q 10/087

(52) U.S. Cl. CPC G06Q 30/0639; G06F 40/284; G06F 40/40; G06Q 10/0877; G06Q 30/06313

(57) ABSTRACT

Systems and methods include obtaining a conversation string through a user interface in a retail location to determine whether to query a database of vectorized product information with numeric vectors. Each numeric vector represents a numeric representation of a description of each of multiple products associated with the retail location. A query with search terms is generated based on the conversation string and vectorized to produce a vector of numeric values. A set of similarity scores are determined between the vectorized query and corresponding numeric vectors from the vectorized product information and a result set of a predefined size is determined as a function of the similarity scores. A conversational output indicative of one or more recommended products is produced with an artificial intelligence model based on the result set. A path through the retail location is displayed to direct the customer to the one or more recommended products.

### CROSS-REFERENCE TO RELATED APPLICATION

The present application claims the benefit of U.S. Provisional Patent Application No. 63/742,608, filed Jan. 7, 2025, the disclosure of which is incorporated herein by reference.

### BACKGROUND

In an effort to obtain greater efficiencies, retailers often incorporate self-checkout systems at the Point of Sale (POS) in order to decrease the wait time of customers to have their selected items scanned and purchased at the POS. Self-checkout systems also reduce the footprint required for the checkout systems as assisted checkout systems require less footprint than traditional checkout systems that are staffed with a cashier. Further, self-checkout systems reduce the quantity of cashiers required to staff the self-checkout systems as one or two cashiers may be able to manage several self-checkout systems rather than having a cashier positioned at every checkout system. However, typical self-checkout systems require the customer to scan one selected item for purchase at a time for items that have Universal Product Code (UPC) and items that do not have a UPC require the customer to laboriously type in or otherwise look up the name of the item at the self-checkout system. Further, errors often happen in which an item was not properly scanned and/or properly identified causing the self-checkout system to pause and require intervention by a cashier.

In addition to the above, there are often occasions in which a cashier or other customer service employee is preoccupied, rendering them unable to assist a growing queue of customers who may only need to be directed to a small number of products. Accordingly, a customer may wait a prolonged period of time to receive assistance or may search the entire store for the product they are interested in purchasing, ultimately resulting in a negative experience.

### BRIEF SUMMARY

Embodiments of the present disclosure relate to automatically directing a customer to a product or set of products in a retail location based on an artificial intelligence model. A system may be implemented to automatically determine, through a conversation with a consumer via a user interface at the retail location, a set of one or more products to recommend to the customer and route the customer to the recommended products within the store using a generated path grid produced from map data associated with the retail location. The system includes at least one processor and a memory coupled with the at least one processor. The memory includes instructions that when executed by the at least one processor cause the processor to obtain a conversation string through a user interface in a retail location to determine, with an artificial intelligence model, whether to query a database of vectorized product information. The vectorized product information is indicative of a plurality of numeric vectors. Each numeric vector represents a numeric representation of at least a description of each of multiple products associated with the retail location. The conversation string is generated based on one or more of typed input or speech recognition. The processor is configured to generate, in response to a determination to query the database of vectorized product information, a query that includes a set of search terms based on a conversational context associated with the conversation string obtained through the user interface in the retail location. The processor is also configured to append a predefined response to the query to restrict a response from the artificial intelligence model to a target distribution of possible responses. The processor is also configured to vectorize the generated query to produce a vector of numeric values. In addition, the processor is configured to determine a set of similarity scores. Each similarity score is indicative of a similarity between the vectorized query and a corresponding numeric vector in the database of vectorized product information. Further, the processor is configured to determine a result set of a predefined size as a function of the similarity scores including mapping each product represented in the result set to corresponding human-readable data indicative of a description of the corresponding product. The processor is also configured to produce, with the artificial intelligence model and as a function of a conversational context, a conversational output indicative of one or more recommended products from the result set for use by a customer to obtain the product from the retail location. Additionally, the processor is configured to display, with the user interface and based on a generated path grid produced from map data indicative of a floor plan and product locations, an image representative of a path through the retail location to direct the customer to the one or more recommended products.

In an embodiment, a method for automatically directing a customer to a product within a retail location is based on an artificial intelligence model. The method includes obtaining a conversation string through a user interface in a retail location to determine, with an artificial intelligence model, whether to query a database of vectorized product information. The vectorized product information is indicative of a plurality of numeric vectors. Each numeric vector represents a numeric representation of at least a description of each of multiple products associated with the retail location. The conversation string is generated based on one or more of typed input or speech recognition. The method also includes generating, in response to a determination to query the database of vectorized product information, a query. The query includes a set of search terms based on a conversational context associated with the conversation string that was obtained through the user interface in the retail location. The method also includes appending a predefined response to the query to restrict a response from the artificial intelligence model to a target distribution of possible responses. Further, the method includes vectorizing the generated query to produce a vector of numeric values. Additionally, the method includes determining a set of similarity scores. Each similarity score is indicative of a similarity between the vectorized query and a corresponding numeric vector in the database of vectorized product information. In addition, the method includes determining a result set of a predefined size as a function of the similarity scores. The method also includes mapping each product represented in the result set to corresponding human-readable data indicative of a description of the corresponding product. Further, the method includes producing, with the artificial intelligence model and as a function of a conversational context, a conversational output. The conversational output is indicative of one or more recommended products from the result set, for use by a customer to obtain the product from the retail location. Additionally, the method includes displaying, with the user interface and based on a generated path grid produced from map data indicative of a floor plan and product locations, an image representative of a path through the retail location to direct the customer to the one or more recommended products.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 depicts an illustration of an item identification configuration for identifying items positioned at a POS system based on feature vectors associated with the item and for routing a customer to one or more recommended products in a retail location;

FIG. 2 depicts an illustration of an example system of item identification and monitoring a journey of a customer through a retail location;

FIG. 3 depicts a flow diagram indicative of a pipeline for generating recommendations for products;

FIG. 4 depicts a flow diagram indicative of a pipeline for routing a customer through a retail location to one or more products within the retail location;

FIG. 5 depicts an illustration of an example route through a retail location to a set of products;

FIGS. 6-9 depict an illustration of a flow diagram of an example method for recommending one or more products to a customer; and

FIGS. 10-11 depict an illustration of a flow diagram of an example method for routing a customer through a retail location to one or more products.

### DETAILED DESCRIPTION

Embodiments of the disclosure generally relate directing a customer to a set of one or more products, including recommending the product(s) and routing the customer to the product(s) based on floorplan information and product information associated with the retail location. In the illustrative embodiment, and as described in more detail herein, the retail location is equipped with a system for assisted checkout in which items positioned at the Point of Sale (POS) system are automatically identified thereby eliminating the need for the customer and/or cashier to scan and/or identify items that cannot be scanned manually. In an example embodiment, the customer approaches the POS system and positions the items which the customer requests to purchase at the POS system. Cameras positioned at the POS system capture images of each item and then an item identification computing device may then extract item parameters associated with each item from the images captured of each item by the cameras. The item parameters associated with each item are specific to each item and when combined may identify the item thereby enabling identification of each corresponding item. Item identification computing device may then automatically identify each item positioned at the POS system based on the item parameters associated with each item as extracted from the images captured of each item. In doing so, the customer simply has to position the items at the POS system and is not required to scan and/or identify items that cannot be scanned. The cashier simply needs to intervene when there is an issue when an item is not identified by item computing device.

However, in an embodiment, item identification computing device may continuously learn via a neural network in identifying each of the numerous items that may be positioned at the POS system for purchase by the customer. Each time that an item that is positioned at the POS system for purchase that item identification computing device does not identify, such item parameters associated with the unknown item may be automatically extracted from the images captured of the unknown item by item identification computing device and provided to a neural network. The neural network may then continuously learn based on the item parameters of the unknown item thereby enabling item identification computing device to correctly identify the previous unknown item in subsequent transactions. The unknown item may be presented at numerous different locations in which item identification computing device automatically extracts the item parameters of the unknown item as presented at numerous different locations and provided to the neural network such that the neural network may continuously learn when the unknown item is presented at any retail location thereby significantly decreasing the duration of time required for item identification computing device to correctly identify the previously unknown item. Further, and as described in more detail herein, the system recommends products to a customer. In an example, a customer may enter the retail location and provide a conversation string (e.g., a natural language question) to a computing device using a user interface, asking whether a particular product or category of product is available in the store. In response, using an artificial intelligence model, the computing device provides a conversational response recommending a set of one or more products and may route the customer to each of the recommended products within the retail location, such as by displaying an image of a suggested route through the retail location that includes the locations of each of the recommended products.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

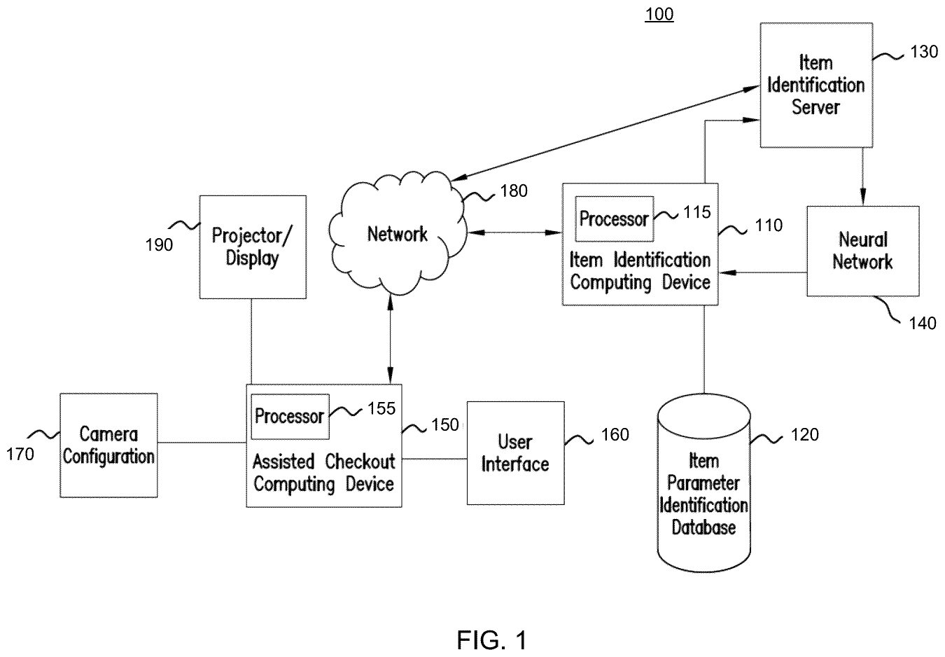

As shown in FIG. 1, an item identification configuration 100 includes an item identification computing device 110, an assisted checkout computing device 150, a camera configuration 170, a user interface 160, a projector/display 190, an item identification server 130, a neural network 140, an item parameter identification database 120, and a network 180. Item identification computing device 110 includes a processor 115. Assisted checkout computing device 150 includes a processor 155.

The checkout process, during which items intended to be purchased by a customer are identified, and prices tallied, by an assigned cashier. The term Point of Sale (POS) is the area within a retail location at which the checkout process occurs. Conventionally, the checkout process presents the greatest temporal and spatial bottleneck to profitable retail activity. Customers spend time spent waiting for checkout to commence in a checkout line staffed by a cashier where the cashier executes the checkout process and/or in a line waiting to engage a self-checkout station and completing checkout where the cashier scans the items individually and/or the customer scans the items individually in a self-checkout station.

As a result, the checkout process reduces the turnover of customers completing journeys within the retail location in which the journey of the customer is initiated when the customer arrives at the retail location and continues as the customer proceeds through the retail location, and concludes when the customer leaves the retail location. The reduction in turnover in the customers completing journeys results in a reduction of sales by the retailer as customers are simply proceeding through the retail location less and thereby reducing the opportunity for the customers to purchase items. The conventional checkout process also impedes the flow of customer traffic within the retail location and also serves as a point of customer dissatisfaction in the shopping experience, as well as posing a draining and repetitive task for cashiers. Customers also appreciate and expect human interaction during checkout, and conventional self-checkout systems are themselves a point of aggravation in the customer experience.

Item identification configuration 100 may provide a defined checkout plane upon which items are placed at the POS system for recognition by item identification computing device 110. Assisted checkout computing device 150 may then automatically list items presented at the POS system for purchase by their customer and tally the prices of the items automatically identified by item identification computing device 110. In doing so, the human labor associated with scanning the items one-by-one and/or identifying the items one-by-one may be significantly reduced for the cashiers as well as the customers. Item identification configuration 100 may implement artificial intelligence to recognize the items placed on the checkout plane at the POS system at once, even when such items may be bunched together to occlude views of portions of some of the items, and of continually improving the recognition accuracy of item identification computing device 110 through machine learning.

A customer may enter a retail location of a retailer and browse the retail location for items in which the customer requests to purchase from the retailer. The retailer may be an entity that is selling items and/or services for purchase. The retail location may be a brick and mortar location and/or an on-site location that the customer may physically enter and/or exit the retail location when completing the journey of the customer in order to purchase the items and/or services located at the retail location. As noted above, the retail location also includes a POS system in which the customer may engage to ultimately purchase the items and/or services from the retail location. The customer may then approach the POS system to purchase the items in which the customer requests to purchase.

In doing so, the customer may present the items at the POS system in which the POS system includes a camera configuration 170. Camera configuration 170 may include a plurality of cameras positioned in proximity of the checkout plane such that each camera included in camera configuration 170 may capture different perspectives of the items positioned in the checkout plane by the customer. For example, the checkout plane may be a square shape and camera configuration 170 may then include four cameras in which each camera is positioned in one of the corresponding corners of the square-shaped checkout plane. In doing so, each of the four cameras may capture a different perspective of the square-shaped checkout plane thereby also capturing a different perspective of the items positioned on the checkout plane for purchase by the customer. In another example, camera configuration 170 may include an additional camera positioned above the checkout plane and/or an additional camera positioned below the checkout plane. Camera configuration 170 may include any quantity of cameras positioned in any type of configuration to capture different perspectives of the items positioned in the checkout plane for purchase that will be apparent to those skilled in the relevant art(s) without departing from the spirit and scope of the invention.

The POS system may also include assisted checkout computing device 150.

Assisted checkout computing device 150 may be the computing device positioned at the POS system that enables the customer and/or cashier to engage the POS system. Assisted checkout computing device 150 may include user interface 160 such that user interface displays each of the items automatically identified as positioned at the POS system for purchase as well as the price of each automatically identified item as well as the total cost of the automatically identified item. Assisted checkout computing device 150 may also display via user interface any items that were not automatically identified and enable the cashier and/or customer to scan the unidentified item. Assisted checkout computing device 150 may be positioned at the corresponding POS system at the retail location.

One or more assisted checkout computing devices 150 may engage item identification computing device 110 as discussed in detail below in order to interface with each of the customers and/or cashiers in real-time via user interface 160 with regard to their request for purchase of the item. Examples of assisted checkout computing device 150 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure. As described in more detail herein, the one or more of the assisted checkout computing devices 150 may, through the corresponding user interface 160 and, in at least some embodiments, through engagement with the computing device 110, direct or route a customer to a set of one or more recommended products, based on a conversational interaction with the customer. That is, the one or more computing devices 150 may receive, from a customer, a natural language query, such as through typed text or speech recognition, inquiring as to the availability of a product, set of products, or category of products. In response, the computing device 150 may utilize an artificial intelligence model, such as the neural network 140, to determine whether one or more matching products are available in the retail location and may present information about the matching products as the set of recommended products. Further, in doing so, the assisted checkout computing device 150 may display, with the user interface 160, a map indicating a path through the retail location to obtain each product in the set of recommended product(s).

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 110 may be a device that is identifying items provided to assisted checkout computing device 150 for purchase based on images captured by camera configuration 170. Examples of assisted checkout computing device 150 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 110 may be positioned at the retail location, may be positioned at each POS system, may be integrated with each assisted checkout computing device 150 at each POS system, may be positioned remote from the retail location and/or assisted checkout computing device 150 and/or any other combination and/or configuration to automatically identify each item positioned at the POS system and then the identification displayed by assisted checkout computing device 150 that will be apparent to those skilled in the relevant art(s) without departing from the spirit and scope of the invention.

Rather than have a cashier then proceed with scanning the items in which the customer requests to purchase and/or have the customer scan such items as positioned at the POS system, item identification computing device 110 may automatically identify the items in which the customer requests to purchase based on the images captured of the items by camera configuration 170. Assisted checkout computing device 150 may then automatically display the items in which the customer requests to purchase via user interface 160 based on the automatic identification of the items by item identification computing device 110. The customer may then verify that the displayed items are indeed the items that the customer requests to purchase and proceed with the purchase without intervention from the cashier.

As a result, the retailer may request that numerous items in which the retailer has for purchase in the numerous retail locations of the retailer be automatically identified by item identification computing device 110 as the customer presents any of the numerous items at the POS system to purchase. The retailer may have numerous items that differ significantly based on different item parameters. Each item includes a plurality of item parameters that when combined are indicative as to an identification of each corresponding item thereby enabling identification of each item by item identification computing device 110 based on the item parameters of each corresponding item. The item parameters associated with each item may be specific to the corresponding item in which each time the item is positioned at the POS system, the images captured of the corresponding item by camera configuration 170 depict similar item parameters thereby enabling item identification computing device 110 to identify the item each time the item is positioned at the POS system. The item parameters associated with each item may also be repetitive in which substantially similar items may continue to have the same item parameters such that the item parameters provide insight to item identification computing device 110 as to the item that has been selected for purchase by the customer. In doing so, the item parameters may be repetitively incorporated into substantially similar items such that the item parameters may continuously be associated with the substantially similar items thereby enabling the item to be identified based on the item parameters of the substantially similar items.

For example, a twelve ounce can of Coke includes item parameters specific to the twelve ounce can of Coke such as the shape of the twelve ounce can of Coke, the size of the twelve ounce can of Coke, the lettering on the twelve ounce can of Coke, the color of the twelve ounce can of Coke and so on. Such item parameters are specific to the twelve ounce can of Coke and differentiate the twelve ounce can of Coke from other twelve ounce cans of soda pop thereby enabling item identification computing device 110 to automatically identify the twelve ounce can of Coke based on such item parameters specific to the twelve ounce can of Coke. Additionally, each twelve ounce can of Coke as canned by Coca-Cola and distributed to the retail locations include substantially similar and/or the same item parameters as every other twelve ounce can of Coke canned by Coca-Cola and then distributed to the retail locations. In doing so, each time a twelve ounce can of Coke is positioned at any POS system at any retail location, item identification computing device 110 may automatically identify the twelve ounce can of Coke based on the repetitive item parameters specific to every twelve ounce can of Coke.

Item parameters may include but not limited to such as brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention.

In doing so, each item in which the retailer requests to be automatically identified by and displayed by assisted checkout computing device 150 may be presented to item identification computing device 110 such that item identification computing device 110 may be trained to identify each item in offline training. The training of item identification computing device 110 in offline training occurs when the item is provided to item identification computing device 110 for training offline from when the item is presented to assisted checkout computing device 150 such that offline training occurs independent from actual purchase of the item as presented to assisted checkout computing device 150. Each item may be presented to item identification computing device 110 such that item identification computing device 110 may scan each item to incorporate the item parameters of each item as well as associate the item parameters with a UPC and/or SKU associated with the item. Item identification computing device 110 may then associate the item parameters of the item to the UPC and/or SKU of the item and store such item parameters that are specific to the item and correlate to the UPC and/or SKU of the item in the item parameter identification database 120. For purpose of simplicity, UPC may be used throughout the remaining specification but such reference may include but is not limited to UPCs, IANs, EANs, SKUs, and/or any other scan related identification protocol that will be apparent from those skilled in the relevant art(s) without departing from the spirit and scope of the present disclosure.

Each iteration that the item is scanned by item identification computing device 110, such item parameters of the item of each scan may further be stored in item parameter identification database 120. The item parameters captured for each iteration of scanning the item may then be provided to item identification server 130 and incorporated into neural network 140 such that neural network 140 may continue to learn as to the item parameters associated with the item for each iteration thereby increasing the accuracy of item identification computing device 110 correctly identifying the item. In doing so, assisted checkout computing device 150 also increases the accuracy in displaying to the customer via user interface 160 the correct identification of the item in which the customer presents to the POS system to request to purchase thereby streamlining the purchase process for the customer and the retailer.

However, such training of item identification computing device 110 occurs in offline training in which the retailer presents a list of the items that the retailer requests to be automatically identified in which the list includes the item and corresponding UPC. Each item on the list is then provided to item identification computing device 110 and each item is continuously scanned by item identification computing device 110 in order for a sufficient quantity of iterations to be achieved until item identification computing device 110 may accurately identify the item. Such offline iterations is time consuming and costly as assisted checkout computing device 150 may fail in accurately displaying the identification of the item to the customer via user interface 160 in which the customer requests to purchase until item identification computing device 110 has obtained the sufficient of quantity of iterations to correctly identify the item via neural network 140.

Further, the retailer may continuously be adding new items to the numerous retail locations of the retailer in which such new items are available to purchase by the customer. Item identification computing device 110 may have not had the opportunity to be trained on the continuously added new items in offline training. Often times, the retailer has numerous retail locations and the retailer may not have control over their own supply chain. In doing so, the retailer may not know when items will be arriving at each of the numerous retail locations as well as when the items will be ultimately purchased and discontinued at each of the numerous retail locations. As a result, item identification computing device 110 may not have the opportunity to execute offline learning of such numerous items at each of the numerous retail locations. In doing so, the new items may be continuously presented for purchase to assisted checkout computing device 150 but assisted checkout computing device 150 may fail to correctly display identification of the item to the customer via user interface 160 due to item identification computing device 110 not having the opportunity to receive the quantity of iterations in offline training to identify the new items.

However, each time that the customer presents an item to assisted checkout computing device 150 in which item identification computing device 110 may not have had sufficient iterations to train in offline manner to identify the item may actually be an iteration opportunity for item identification computing device 110 to train in identifying the item in online training. Item identification computing device 110 may train in identifying the item in online training when the customer presents the item to assisted checkout computing device 150 for purchase such that camera configuration 170 captures images of the item parameters associated with the item thereby enabling item identification computing device 110 to capture an iteration of training at the POS system of the item rather than doing so offline.

The retailer may experience numerous transactions in which the customer requests to purchase the item in which item identification computing device 110 has not had the opportunity to sufficiently train in offline training. Such numerous transactions provide the opportunity for item identification computing device 110 to train in online training to further streamline the training process in identifying the items. Further, the training of item identification computing device 110 with iterations provided by the customer requesting to purchase the item at the POS system further bolsters the accuracy in the identification of the item by item identification computing device 110 even after item identification computing device 110 has been sufficiently trained with iterations in offline training. Thus, the time in which to train item identification computing device 110 to accurately identify the item is decreased as well as the overhead to do so by adding the online training to supplement the offline training of item identification computing device 110.

As a result, the automatic identification of the items positioned at assisted checkout computing device 150 at the POS by item identification computing device 110 may enable the retailer to have the staff working at each retail location to execute tasks that have more value than simply scanning items. For example, the staff working at each retail location may then greet customers, stock shelves, perform office administration, and/or any other task that provides more value to the retailer as compared to simply scanning items. In doing so, the retailer may reduce the quantity of staff working at each retail location during each shift while also gaining more value from such staff working at each retail location during each shift due to the increase in value of the tasks that each staff member may now execute without having to scan items and/or manage a conventional self-checkout system that fails to automatically identify the items positioned at such conventional POS systems. The automatic identification of the items positioned at assisted checkout computing device 150 at the POS may also enable the retailer to execute a fully autonomous self-checkout system in addition to also reducing staff. Regardless, the automatic identification of the items positioned at assisted checkout computing device 150 at the POS provides the retailer with increased flexibility in staffing each retail location during each shift.

Item identification computing device 110 may be a device that is identifying items provided to assisted checkout computing device 150 for purchase based on images captured by camera configuration 170. One or more assisted checkout computing devices 150 may engage item identification computing device 110 in order to interface with of each of the customers and/or cashiers in real-time via user interface 160 with regard to their request for purchase of the item. User interface 160 may include any type of display device including but not limited to a touch screen display, a liquid crystal display (LCD) screen, a light emitting diode (LED) display and/or any other type of display device that includes a display that will be apparent from those skilled in the relevant art(s) without departing from the spirit and scope of the present disclosure.

### In-Store Connectivity of Example Assisted Checkout Devices

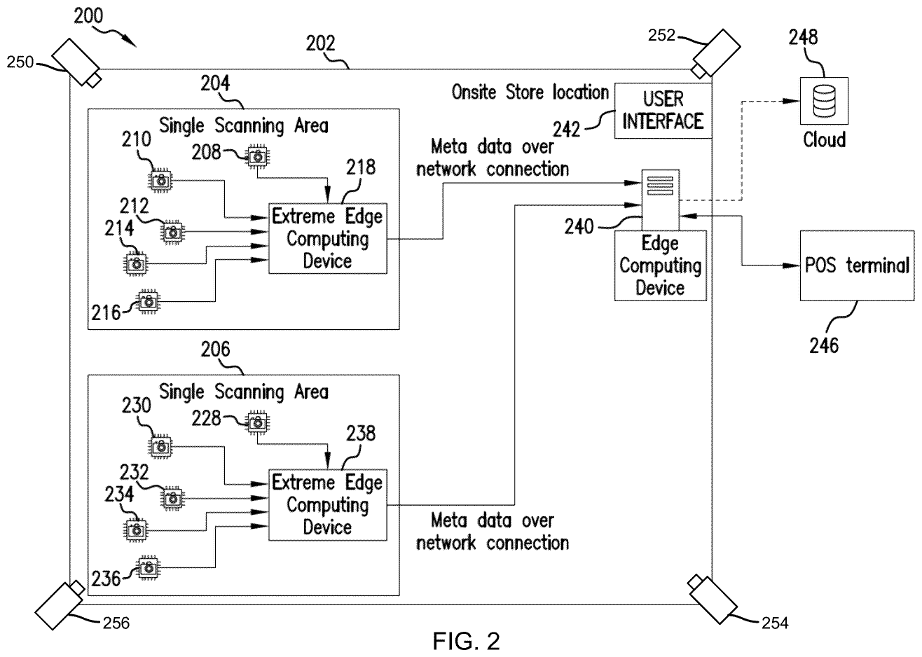

FIG. 2 shows a block diagram of an example assisted checkout system 200 within a single store 202. The system 200, in at least some embodiments, corresponds with the configuration 100 of FIG. 1. The store 202 can have multiple assisted checkout stations 204, 206 each equipped with an assisted checkout device (e.g., assisted checkout computing device 150). The example illustrated in FIG. 2 has two checkout stations 204, 206, but other examples can have more or fewer assisted checkout stations. Each assisted checkout station can include a number of cameras and an associated extreme edge computing device. In the illustrated example, a first extreme edge computing device 218 at the first assisted checkout station 204 is coupled to receive video streams from five cameras 208, 210, 212, 214, 216, and a second extreme edge computing device 238 at the second assisted checkout station 206 is coupled to receive video streams from five other cameras 228, 230, 232, 234, 236.

The cameras 208, 210, 212, 214, 216, 228, 230, 232, 234, and 236 can be coupled to their respective extreme edge computing devices 218, 238 using any suitable wired or wireless link or protocol. Providing the camera links as direct wired links, e.g., over USB, as opposed to indirect wired links or wireless links, e.g., over internet protocol (IP), has dependability and robustness advantages, in that each assisted checkout system need not be reliant on local area network (e.g., Wi-Fi) internet connectivity within the store 202, which may be slow, congested, or intermittent.

The extreme edge computing devices 218, 238 can each be any computing system capable of receiving and processing video streams from their respective cameras. In some examples, each extreme edge computing device 218, 238 is equipped with an AI acceleration unit, e.g., a graphics processing unit (GPU) or tensor processing unit (TPU), to provide the computing capability that may be required to process the video streams in accordance with computer vision methods described in greater detail below. In some embodiments, the extreme edge computing devices 218, 238 can include a complete computer system with an AI acceleration unit and a heat sink in a self-contained package. Provided with video streams from their respective video cameras, each extreme edge computing device 218, 238 derives and outputs metadata indicative of items detected on a checkout plane of a respective checkout station 204 or 206. In some examples, not shown in FIG. 2, a single extreme edge computing device can be coupled to the cameras from multiple (e.g., two) assisted checkout stations and can perform video stream receipt and processing functions for all of the multiple assisted checkout stations for which it is connected to cameras. The handling of multiple assisted checkout stations by a single extreme edge computing device reduces system costs and increases operational efficiency.

Each extreme edge computing device 218, 238 can, in turn, be wired or wirelessly coupled to another computing device 240 located on-site within the store 202, referred to herein as an edge computing device, e.g., over various network connections such as an Ethernet or Wi-Fi local area network (LAN) using an internet protocol. In some examples (not shown), the store 202 is provided with multiple edge computing devices 240. Each edge computing device 240 is likewise equipped with an AI acceleration unit (e.g., GPU or TPU) to provide the computing capability that may be required to train or re-train machine learning (ML) models as described in greater detail below. A POS terminal 246, or multiple such terminals, can be coupled to the edge computing device 240 (as shown) and/or to individual ones of the extreme edge computing devices 218, 238 (not shown). Each edge computing device 240 can communicate (e.g., over the internet) with remotely hosted computing systems 248 configured for distributed computation and data storage functions, referred to herein as the cloud.

The edge computing device 240 can configure and monitor the extreme edge computing devices 218, 238 to which it is connected to enable and maintain assisted checkout functionality at each assisted checkout station 204, 206. For example, the edge computing device 240 can treat the extreme edge computing devices 218, 238 as a distributed computing cluster managed, for example, using Kubernetes. An edge computing device in a store can thus provide a single point of contact for monitoring all of the extreme edge computing devices in the store, through which all of the edge computing devices can be managed, e.g., remotely managed over the cloud via a web-based configuration application. Advantageously, each store can be provided with at least two extreme edge computing devices 218, 238 to ensure checkout reliability through system redundancy. The edge computing device 240 can also receive data and metadata from the extreme edge computing devices 218, 238, enabling it to train or retrain ML models and thus improve assisted checkout functionality over time. In some examples, the edge computing device 240 and the extreme edge computing devices 218, 238 can be accessed and configured via a user interface (UI) 242, e.g., a graphical user interface (GUI), that can be accessible via a web browser.

In some examples, not shown in FIG. 2, one or more cameras associated with an assisted checkout station 204, 206 can connect directly to the edge computing device 240, rather than to the corresponding extreme edge computing device 218, 238. For example, an assisted checkout device at an assisted checkout station may have four USB cameras coupled to its associated extreme edge computing device, and a fifth (e.g., overhead) camera that is an IP camera that streams via wired or wireless connection to the store's edge computer device. In some examples, metadata derived from the video stream data from the fifth (IP) camera, generated at the edge computing device, can be merged at the edge computing device with metadata derived from the video stream data from the four USB cameras, generated at the extreme edge computing device associated with the checkout station, to provide an enhanced interpretation of the scene observed by all five cameras associated with the checkout station. The combination of AI-acceleration-unit-enabled extreme edge computing devices and an AI-acceleration-unit-enabled edge computing device can thus result in more efficient distribution of data processing tasks while simplifying infrastructure setup and maintenance and reducing network bandwidth that would otherwise be associated with streaming all assisted checkout camera outputs directly to an edge computing device over a local area network. Although described by way of example as connecting to another fifth (e.g., overhead) camera, it should be appreciated that many cameras may connect directly to the edge computing device 240 (e.g., some or all of the cameras in an existing security camera infrastructure) in some embodiments. The existing security camera infrastructure may include a set of security cameras 250, 252, 254, 256 located at various points within the retail location (onsite store location) to provide a comprehensive view of activities of people within the retail location. The security cameras may be communicatively connected to the computing devices 218, 238, 240 via wired or wireless connections, similar to those discussed above with reference to the cameras 208, 210, 212, 212, 214, 216, 228, 230, 232, 234, 236.

In some examples, the edge computing device 240 can be used to collect visual analytics information provided by a visual analytics system running on the edge computing device 240. The visual analytics information can include information about individual customer journeys through the store: paths taken through the store, items observed or interacted with (e.g., picked up), areas of interest entered (e.g., a coffee station, a beverage cooler, a checkout queue, a checkout station), and other gestures, behaviors, and activities observed. Advantageously, such information can be garnered from existing security camera infrastructure, such as cameras 250, 252, 254, 256 without using facial recognition or obtaining personally identifying information (PII) about the customers observed in the store. The edge computing device 240 can collate this video analytics information and combine it with information from the assisted checkout extreme edge computing devices 218, 238, such as checkout list predictions, to produce more accurate checkout list predictions on the edge computing device 240. In some examples, the video analytics information can be used for checkout, e.g., to produce a checkout list. In some embodiments, the video analytics information may be utilized to provide positive or negative reinforcement to an artificial intelligence-based loss prevention system, executed by one or more of the computing devices 218, 238, 240, that predicts whether a customer interaction at a user interface (e.g., a request for the most expensive products in the retail location, a request for the locations of specific products) and subsequent movements by the customer (e.g., including whether the customer actually went to an assisted checkout station 204, 206 after visiting the location(s) of one or more products) within the retail location are indicative of a higher or lower likelihood of theft of one or more products from the retail location, as described in more detail herein.

In some examples, inferencing using machine learning (ML) models, including those for detecting items and predicting what items appear in a scene, can be run on the extreme edge computing devices 218, 238, such that ML computational tasks are only offloaded to the edge computing device 240 for incremental training of ML models in real time. In the most frequent examples of operation of assisted checkout, each extreme edge computing device 218, 238 may send only generated metadata, rather than video streams or image data, to the edge computing device 240. The edge computing device 240 can be configured to maintain databases of items and sales, can communicate with the POS terminal 246, and can store feedback from the POS terminal 246. In some examples, each extreme edge computing device 218, 238 can operate generally to stream generated metadata unidirectionally to the edge computing device 240, by deriving still images from video streams and processing the still images to determine predictions regarding items in an observed scene over the checkout plane. ML learning, collection of feedback from cashiers, communicating with the POS, and storing of metadata can all take place on the edge computing device 240. Feedback from the cashiers collected by the edge computing device 240 can, in some examples, be used to train ML models either on the edge computing device 240 or on the cloud. Newly trained or re-trained ML models can be provided from the edge computing device 240 back to the extreme edge computing devices 218, 238.

### Conversation Model and Recommendation Pipeline

To reduce the likelihood of a situation in which employees of the retail location are preoccupied with other work and a queue of customers is awaiting directions to a set of products within the retail location, the system 200 in the configuration 100 of FIG. 1 may implement an artificial intelligence assistant pipeline. In doing so, the system 200 in the configuration 100 of FIG. 1 may provide a solution for customers who wish to find products and receive recommendations in a timely manner, while also reducing the stress and workload of employees in the retail location. In operation, the system 200 serves as a search and retrieval assistant that is capable of conversationally determining and narrowing down customer needs in order to query relevant production information, select the most appropriate products from the retrieved information, and guide the customer to the desired location(s) (e.g., locations of the appropriate product(s) within the retail location). Further, and as described in more detail herein, the system 200 in the configuration 100 may perform a method of behavioral data collection and analysis. Interactions with the system may be tied with other gathered data to assist with loss prevention by silently flagging suspicious behavior. The system may also use the interactions to automatically create new training data. The data may also be used to more broadly recommend products based on individual customer profiles and even customer relationships.

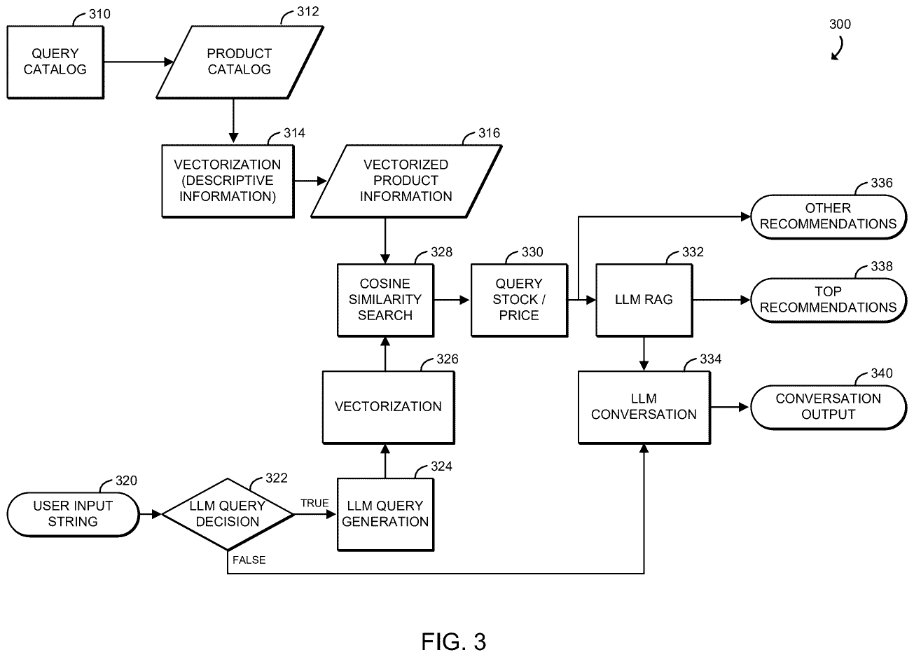

In at least some embodiments, the system shown in the configuration 100, utilizes an artificial intelligence model, such as a large language model (LLM). The LLM may be incorporated into the neural network 140 of FIG. 1, in at least some embodiments. In some embodiments, the LLM may be the Google Gemma 2 9B Instruct model. Further, to improve memory efficiency, in at least some embodiments, the LLM (e.g., the Google Gemma 2 9B Instruct model) may be quantized to fit within approximately 15 gigabytes of memory, thereby increasing the availability of the LLM to operate at the extreme edge, such as in one or more of the extreme edge computing devices 218, 238. Additionally or alternatively, the LLM may operate at the edge computing device 240 and/or in the cloud 248. Referring now to FIG. 3, the recommendation pipeline 300 may include two primary components: a vectorized database of product information 316 and LLM-based recommendation system to support the operations shown in FIG. 3. As shown in blocks 310, 312, 314, 316 of FIG. 3, the system 200 performs database vectorization. That is, in the illustrative embodiment, the system 200 vectorizes descriptive information from a product catalog 312 row by row. The descriptive information may include a name, category, and related information for each product sold by a retailer associated with a given retail location and may be in a textual format. In vectorization, input data, such as text, is transformed into a vector representation (e.g., a set of contiguous numeric values, in a data structure known as a vector) that is indicative of the original input data. Conversion to a vector of numeric values enables the data to be more readily operated on by machine learning algorithms, to increase the execution speed and reduce any training time associated with machine learning operations. In at least some embodiments, the system 200 vectorizes the product catalog 312 using MiniLM-L6-v2. Further, in at least some embodiments, the product catalog 312 may be embodied as a comma separated value (.csv) file with approximately 15,000 products, each associated with a corresponding stock keeping unit (SKU).

The system 200 stores the vectorized product information 316 in memory. In some embodiments, the system 200 continually rebuilds the vectorized product information 316 by re-querying relevant products from a corresponding database to obtain updated descriptive information for the products, and perform the vectorization operations 314 to convert the product description information to a vectorized format in the vectorized product information 316. The system 200 may do so at set intervals and/or based on detecting a particular trigger, such as a notification that one or more products were added to or removed from the product catalog 312. In some embodiments, the product catalog 312 also includes product locations, prices, stock information (e.g., amount of each product available in a particular retail location), and/or rating information indicative of user ratings for products.

As indicated in blocks 320, 322, a conversation string (the user input string 320) originating from a typed input or speech recognition, such as via the user interface 160, is received by the system 200 and provided to an artificial intelligence model, such as the LLM (i.e., the neural network 140) to determine if a query for new product information should be performed. In at least some embodiments, the system 200 adds a predefined response after a token associated with the user input string 320 to indicate the start of the artificial intelligence model's turn and to limit the output of the artificial intelligence model to a target distribution of possible responses. In the illustrative embodiment, the target distribution is a true or false response, or, similarly, a yes or no response. The response, in the illustrative embodiment, is a parsable decision that is based on all presently known conversation and product context. That is, the decision from the artificial intelligence model is based on the content of the user input string and any information specified in the user input string that indicates the product(s) that the user is interested in.

Continuing the flow of operations, if the artificial intelligence model determines to begin a query, the artificial intelligence model, in the illustrative embodiment, generates a succinct query of relevant search terms based on the conversation leading up to the query generation. Query generation is represented in block 324 in FIG. 3. Further, in the illustrative embodiment, the system 200 appends a predefined response to enforce a target range of possible outputs from the artificial intelligence model. In block 326, the system 200 vectorizes the query, q (from block 324) to convert the textual information in the query to a corresponding vector of numeric values. As such, the vector of numeric values numerically represents the search terms, which may be parameters or characteristics of a product or set of products that the customer is interested in, based on the conversational context and product information identified by the artificial intelligence model from the user input string 320. In at least some embodiments, the system 200 performs the vectorization of the query, q, using MiniLM-L6-v2. Subsequently, the system 200 performs a cosine similarity search operation 328, as indicated in FIG. 3. That is, in the illustrative embodiment, the system 200 computes a cosine similarity between the vectorized query, from block 326, to each vectorized product description, dᵢ, from the vectorized product information 316 in memory. Further, in the illustrative embodiment, the system 200 performs the cosine similarity determinations in parallel. Equation 1 below represents the cosine similarity determination for each product description, dᵢ.

$$cos {θ}_{i} = \frac{q \cdot {d}_{i}}{‖ q ‖ ‖ {d}_{i} ‖} . \qquad ( Equation 1 )$$

In the illustrative embodiment, the system 200 returns a configurable top K responses and maps those responses back to readable data. Further, in block 330, the system 200 queries price and stock information for the retrieved products (i.e., the top K responses) and adds that price and stock information to a set of information for display to the customer (e.g., via the user interface 160) and to provide additional textual context. The cosine search serves as a low-precision, high-recall system, that contains relevant results. In some embodiments, the system 200 may perform additional thresholding to ensure that the results are pertinent to the query.

The system 200 may perform retrieval augmented generation (RAG) in block 332. In doing so, the system 200 may prompt the artificial intelligence model, which may be an LLM as described above, to select indices corresponding to the products that are most relevant to the conversation and the query. As such, the operations associated with block 332 form an RAG system. If the RAG system provides no recommendations, the system 200, in at least some embodiments, automatically broadens the query. In doing so, the system 200 may replace a brand identified in the query with a general product category. In the illustrative embodiment, the system 200 performs the broadening operation only once per query. The RAG system serves as a way to greatly increase the precision of the cosine search, filtering out irrelevant results.

In a subsequent operation, the system 200 prompts the artificial intelligence model, given all of the available conversational context and data indicative of whether or not the system 200 broadened the query (i.e., as described above), to provide a conversational response. In embodiments in which the underlying artificial intelligence model (e.g., LLM) does not natively support a system prompt, as is the case with Google Gemma 2, the system 200 appends an automated pseudo system message to the last user input to aid in ensuring that the artificial intelligence model remains in a target distribution of outputs that best correspond with the role assigned to the artificial intelligence model. Appending the automated pseudo system message also acts as a form of automatic moderation against malicious prompt injection, serving as a soft override to any attempt to cause the artificial intelligence model to leave the target output distribution and output unintended content. A set of other recommendations 336, top recommendations 338 from the RAG system described above, and the conversation output 340 are shown in FIG. 3. In the illustrative embodiment, the system 200 provides the outputs via a user interface, such as the user interface 160, which is available to a customer in a given retail location.

### Customer Routing

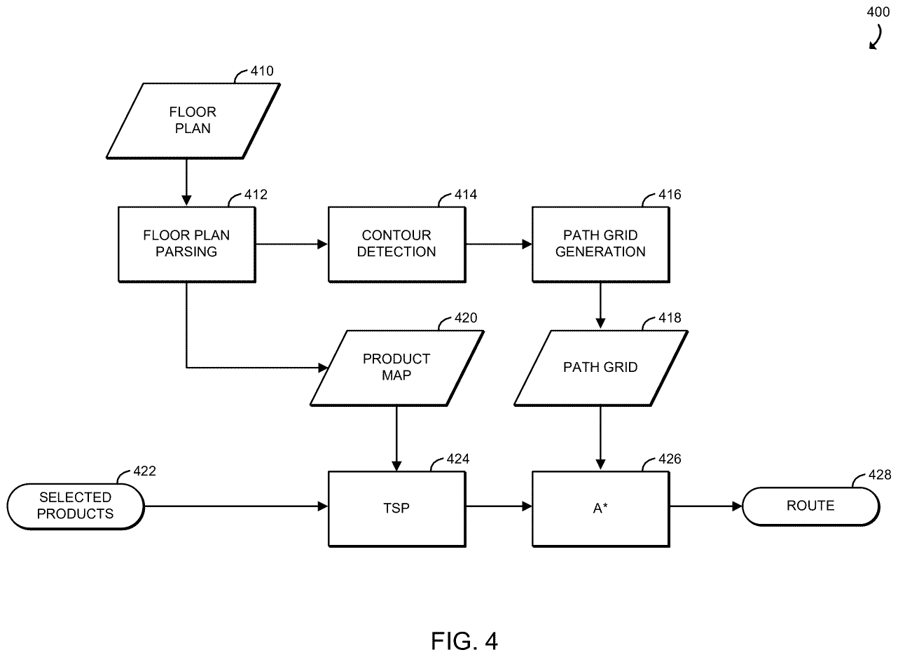

The system 200 may additionally perform customer routing to indicate, to the customer, a path through the retail location to enable the customer to obtain each product from a set of recommended products, such as products recommended via the recommendation pipeline 300 described above. To do so, the system 200 obtains map data indicative of a floor plan of the retail location and positions of products within the retail location. An embodiment of a pipeline 400 for the routing process is shown in FIG. 4. In a set of parsing operations, the system 200 obtains a data set 310 indicative of a floor plan. The data set 410 may be encoded as a drawing exchange format (.dxf) file, a proprietary binary file format that stores two dimensional and three dimensional design data and metadata (e.g., a .dwg file) that is then converted to a drawing exchange format file, or other format. In the illustrative embodiment, in block 412, the system 200 parses the data set 410 indicative of the floor plan to retrieve all polygons that represent physical objects. The system 200 also parses out a bounding box of the floor area. The bounding box may be embodied as a rectangular area that encompasses or bounds an object (e.g., the floor area), defining the location and size by using coordinates of the top-left and bottom-right corners. The system 200, in the illustrative embodiment, also retrieves aisle and location information and saves the information as a dictionary for quick mapping from a location name to a two dimensional coordinate.

After the system 200 has extracted the polygons from the floor plan data set 410, the system 200 may perform one or more operations to correct geometry-related issues, as indicated in block 414. In particular, the polygons represented in the floor plan data set 410 may include disjointed lines that do not directly connect to form an entire polygon. Accordingly, the system 200 may plot the polygons as an image and then utilize contour detection to generate a set of cohesive polygon information. Contour detection is a computer vision operation that utilizes one or more algorithms to determine the shape of objects in images. In doing so, a contour detection algorithm may join all of the pixels along a boundary of an object to create a contour. The boundary of an object may be identified through analysis and identification of pixels having a similar (e.g., within a defined threshold of each other) color or intensity. A contour is a sequence of points indicative of a line or curve that defines the boundary of an object in an image. In some embodiments, in addition to or as an alternative to performing contour detection, the system 200 may perform spatial querying to determine connections between disconnected lines of the polygons from the floor plan data set 410.

In block 416, the system 200 performs path grid generation to generate a path grid 418. That is, the system 200 generates a grid representing entirely open space across the image space. For efficiency, in the illustrative embodiment, the system 200 only analyzes nodes within a corresponding bounding box of each polygon that was extracted from the floor plan data set. If a node within a bounding box falls within the actual polygon corresponding to that bounding box, the system 200 marks the node as an obstacle. Further, in the illustrative embodiment, the system 200 increases a weight associated with each surrounding node that is not an obstacle and that is within a configurable padding distance of the node that is marked as an obstacle. Doing so assists in generation of natural routes that reduce the likelihood of a customer traversing the path from getting too close (e.g., within a predefined distance of) one or more objects.

Having processed the floor plan data set, the system 200 obtains a list of selected products 422, such as the recommended products determined by the artificial intelligence model (e.g., LLM) from the pipeline 300 of FIG. 3. The system 200 maps the locations of the products from a product map 420 to two dimensional coordinates, then solves a traveling salesman problem in block 424, using the position of the user interface 160 as a starting location and the selected products (i.e., the recommended products) as points to visit along the path. The traveling salesman problem (TSP) may be embodied as a non-deterministic polynomial-time (NP) hard problem. The TSP seeks to determine the shortest possible route that visits each destination from a set of destinations exactly once and returns to a starting point. In the implementation utilized by the system 200, the starting point is the location of the user interface 160 through which the customer interacts with the system 200 and the set of destinations is the set of locations of products in the set of recommended products (e.g., the selected products 422). The TSP can be embodied as a graph problem, such as with a undirected weighted graph, in which the product locations (i.e., as two dimensional coordinates) are vertices of the graph, edges of the graph are paths, and the weight of each edge is a distance of the corresponding path. Accordingly, the system 200 may perform a minimization process to minimize the accumulated distances of the paths (e.g., the weights of the edges between vertices in the graph) while starting and ending at the vertex representing the present location of the customer (e.g., at the user interface 160) and visiting each vertex representing a location of a corresponding one of the products in the set of recommended products (e.g., the selected products 422). The TSP may be embodied as an integer linear program, such as Miller-Tucker-Zemlin (MTZ) formulation or a Dantzig-Fulkerson-Johnson (DFJ) formulation, or other formulation. In general, the system 200 may utilize an exact algorithm, a heuristic algorithm to obtain an approximated solution in a shorter amount of time than the exact algorithm, or a combination of approaches, such as identifying scenarios within the TSP in which particular heuristics provide more optimal results than other heuristics or in which an exact algorithm may provide a solution in a similar amount of time as a heuristic, while providing a more optimal solution (e.g., a shorter route through the retail location).

Further, in block 426, the system 200 performs A* path planning between a sorted set of the nodes, thereby generating a list of coordinates in the path grid space. The system 200 then converts the list of coordinates back to the image space to be displayed to the customer, such as via the user interface 160, in block 428. A* is a path finding algorithm that may operate on a graph, using graph traversal. That is, given a weighted graph, a source node, and a goal node, the A* algorithm determines the shortest path from the source to the goal. In the weighted graph, the weights represent distances between nodes in the graph. In at least some embodiments, the system 200 may maintain, in memory, a tree data structure that is indicative of paths originating from the start node and extending the paths one edge at a time until the goal node is reached. Further, over each of multiple iterations of a loop, the system 200 may determine which of the paths to extend, based on a cost of the path and based on an estimate of the cost that will be incurred to extend the path to the goal. In at least some embodiments, the system 200 may utilize a priority queue to perform repeated determination of an estimated minimum cost node to expand the path to. At each iteration of the algorithm, the system 200 may remove, from the queue, the node with the lowest cost, update cost values for the neighboring nodes correspondingly, and add those neighboring nodes to the queue. The system 200 may continue the operations until a removed node is the goal node. In other embodiments, the system 200 may perform a different set of operations to implement the A* path finding solution.

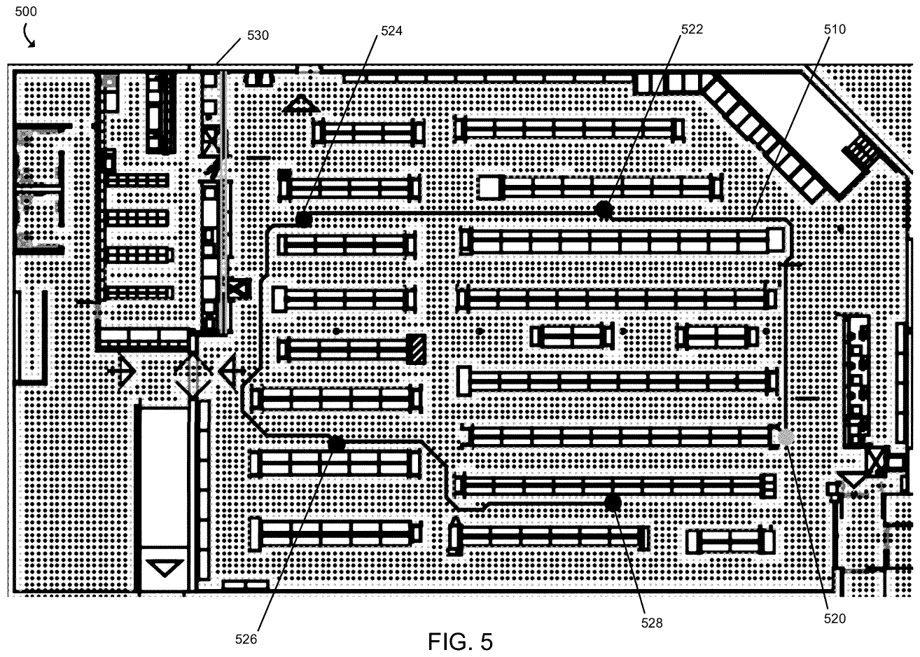

Referring now to FIG. 5, a diagram 500 of an example route 510 that may be produced by the system 200 is based on a floor plan 530 represented in a floor plan data set 410 (i.e., from the pipeline 400). The system 200 may provide a visualization similar to that of the diagram 500 via a user interface (e.g., the user interface 160) to guide a customer to each desired product in the retail location. The path (also referred to as a route) 510 begins at a present location 520 of the customer, which, in some embodiments, may be the location of a user interface 160 through which the customer is interacting with the system 200 (e.g., to request information about one or more products and to obtain information indicative of how to navigate through the retail location to the product(s)). As described above, the system 200 generates the path to visit the location of each product in the set of selected products 422, which is determined by the artificial intelligence model (e.g., LLM) in accordance with the pipeline 300 of FIG. 3. As indicated in the diagram 500, the path 510 extends from the location 520 of the customer to each of multiple product locations 522, 524, 526, 528 within the retail location, while avoiding obstacles such as aisles. The path 510 also returns the customer to the general starting point 520 where the customer may purchase the products taken from the locations 522, 524, 526, 528. The customer may then participate in an assisted checkout process in which an assisted checkout computing device 150 (e.g., an extreme edge computing device 218) identifies each product based on images of the products obtained from different angles by the cameras 208, 210, 212, 214, 216 and analyzes parameters based on those images to determine the corresponding products and prices of the products, as described above in connection with FIGS. 1 and 2.

In some embodiments, rather than utilizing an offline database such as set of product information in comma separated value format, the system 200 may utilize online functionality to pull the most current product information. Querying for such product information may proceed in two stages, as described below. In a first stage, referred to herein as global querying, the system 200 may obtain general product information, which may be unlikely to change frequently for a given facility (e.g., retail location). Accordingly, the system 200 may query descriptive information for a product catalog corresponding to the facility that the system 200 is installed within at set intervals as a separate process, rebuild the vector database (the vectorized product information 316) each time, and store that vectorized product information 316 in memory to enable fast querying. In a second stage, referred to as local querying, once the cosine similarity search has retrieved the top K most similar results (e.g., in block 328 of FIG. 3), the system 200 may query the most important and most likely to change information for each retrieved product. That information may include data such as stock information (i.e., the number of units of the product available in the retail location), pricing, aggregated review score, location, and sales or events that may affect the price.

The system 200, in some embodiments, may have additional features to improve the quality of the cosine similarity search 328, such as more detailed product descriptions and/or summaries of customer reviews. The product descriptions and/or summaries of customer reviews may be utilized by the RAG system represented by block 332 discussed above. The RAG system 332, in some embodiments, is a graph-RAG system that clusters similar products together as a graph and queries the graph rather than utilizing a global cosine similarity search.

In some embodiments, the system 200 may utilize a customer profile for customers that elect to sign in to utilize the system 200. Given a history of purchases, current coupons and sales, and even previous interactions with the system 200, the system 200, in those embodiments, constructs a textual profile for a customer and alters recommendations based on the profile. The system 200 may do so both when constructing a query for the cosine similarity search 328 and/or when selecting product with the RAG system 332. In some embodiments, the system 200 may generate hidden recommendations. For example, in some embodiments, the system 200 globally increases path weights around the path grid for every node except those representing recommended products. Those path weights may apply to products that are not displayed in a list to the customer. Doing so encourages the generation of a path that still progresses in the general direction of desired products but not may be entirely spatially optimal. Rather, as a trade off, the path guides the customer through aisles containing products that the customer may be interested in. In some embodiments, the behavioral analysis component may be utilized by the system 200 to determine if the customer is in a hurry (e.g., exhibiting a sense of urgency) or not, and the system 200 may disable the generation of the less spatially optimal path to reduce the likelihood of the customer having a negative shopping experience.

In some embodiments, the system 200 may apply a rating system at multiple levels for a reinforcement learning component. In doing so, the system 200 may utilize customer ratings to record optimal responses and calculate a reward based on the rating. Further, the system 200 may monitor for suspicious dialogue and behavior and silently flag the dialogue and/or behavior to assist in loss prevention. For example, the system 200 may flag, as suspicious, dialogue from a customer inquiring about the locations of the most expensive products in the retail location. If a customer interacts with the system 200, spends time in the retail location, and the system 200 has determined with high confidence (e.g., satisfying a target confidence score) that the customer interacted with a product (e.g., based on image(s) from one or more of the security cameras 250, 252, 254, 256), then leaves the retail location with no corresponding POS transaction, the system 200 may determine that the probability that he product was stolen is significantly higher. If the customer did in fact steal the product and the system 200 did not produce a silent flag indicating a prediction that the customer would steal the product, the system 200 may calculate a negative reward to adjust the loss-prevention component of the artificial intelligence model. Similarly, if the system 200 triggered a silent flag indicative of a prediction that the customer would steal the product but the customer did not actually steal the product, the system 200 may calculate a negative reward to adjust the operation of the artificial intelligence model to make more accurate predictions related to loss prevention in the future.

The system 200, in some embodiments, may perform operations that take into account the possibility that a customer is purchasing one or more products on behalf of another person. In such a scenario, embodiments of the system 200 that utilize the above-described graph-RAG system or even a model trained specifically on that type of graph structure would produce beneficial results. In some embodiments, the graph may contain different edge types representing the relationships between customers and products and between the customers themselves. Such a graph structure may be utilized by the system 200 to further enhance recommendations based not only on specific customers but also on the people they know. In at least some embodiments, the system 200 may perform automatic detection of certain words and utilize an additional classification model to analyze prompts and conversations to improve self-moderation of the system 200 and to provide additional safety measures on the output on the artificial intelligence model (e.g., the LLM).

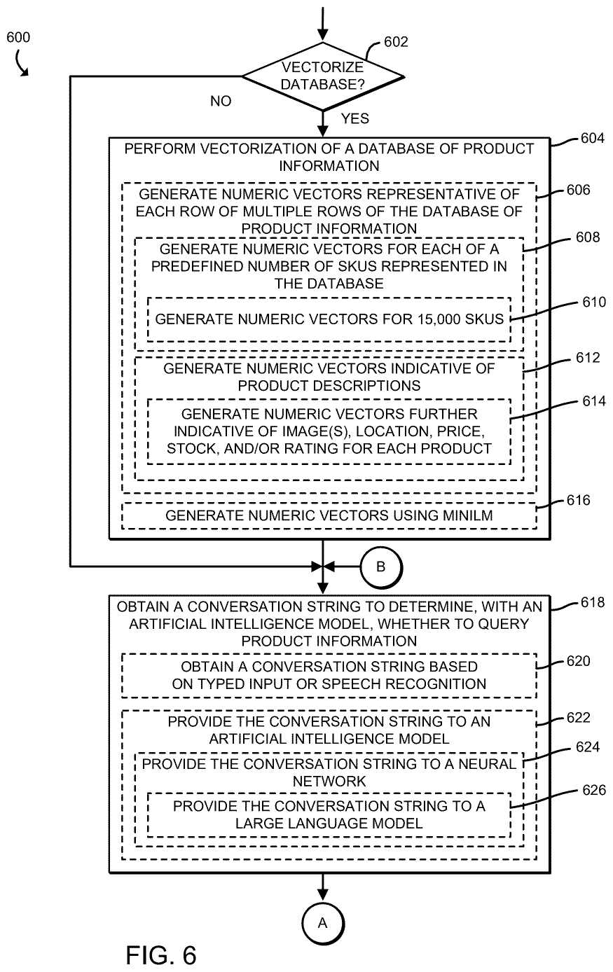

Referring now to FIG. 6, the system 200, in operation, may perform a method 600 for recommending one or more products to a customer using an artificial intelligence model. The description of the method 600 herein expands on the operations described relative to the pipeline 300 of FIG. 3. In the illustrative embodiment, the method 600 begins in block 602 in which the system 200 determines whether to vectorize a database of product information, such as the product catalog 312 shown in FIG. 3. In the illustrative embodiment, the system 200 determines to vectorize the product information if the product information has not been previously vectorized. In some embodiments, the system 200 may continually vectorize the product information, such as on a periodic basis or in response to a determination that a portion of the product information has changed (e.g., product information has been added or remove or modified) since the product information was last vectorized. For example, the system 200 may receive a notification from a computing device associated with a retailer indicating that the product information has been updated. Regardless, in response to a determination to vectorize the product information, the method 600 advances to block 604, in which the system 200 performs vectorization of the database of product information (e.g., the product catalog 312).

In vectorizing the database of product information, the system 200, in the illustrative embodiment, generates numeric vectors that are representative of each row of multiple rows of the database of product information, as indicated in block 606. Each numeric vector is embodied as a data structure that contains a set of numeric values, in which each numeric value has a corresponding index or position within the vector and in which a given property or feature associated with a given product is represented numerically at the same position or index from one numeric vector, associated with one product, to another numeric vector, associated with a different product from the product catalog 312. Each row, in the illustrative embodiment, corresponds to a different product from the product catalog 312. By converting product information from the database (e.g., the product catalog 312) to a numeric form, the system 200 adapts the information for more efficient use by artificial intelligence algorithms that are configured to perform mathematical operations, such as dot products and/or cross products.

In performing vectorization, the system 200 may generate numeric vectors for each of a predefined number of stock keeping units (SKUs) represented in the database of product information (e.g., the product catalog 312), as indicated in block 608. Each SKU corresponds to a different product. In performing vectorization for a predefined number of SKUs, the system 200 may generate numeric vectors for 15,000 SKUs represented in the database of product information, as indicated in block 610. In the illustrative embodiment, if the predefined number of SKUs is less than the total number of SKUs represented in the database of product information, the system 200 may sort the database of product information to rank the SKUs by one or more criteria, such as the quantity of products having a given SKU in a retail location. By doing so, the system 200 may focus the vectorization process on the products that are most plentiful in the retail location and most likely to be of interest to customers.

In the illustrative embodiment, when performing the vectorization process, the system 200 focuses on generating numeric vectors corresponding to product descriptions, which may be embodied as text strings that identify the name and or a summary of what the corresponding product is, as indicated in block 612. As described herein, each numeric vector may ultimately be compared to a query based on a textual conversation with a customer, in which the query is primarily based on a description of the type of product that the customer is interested in and is also converted to a numeric vector. As such, by vectorizing the product description information from the database of product information, the system 200 converts the most pertinent features of the product information into a form that is readily usable in artificial intelligence analysis of which products in a retail location satisfy the query from the customer, such as through a cosine similarity search. In some embodiments, the system 200 may generate numeric vectors that are also representative of one or more of images, location, price, stock, and/or a rating for each product represented in the database of product information (e.g., the product catalog 312), as indicated in block 614. In at least some embodiments, and as indicated in block 616, the system 200 may generate the numeric vectors from the product information using MiniLM. In doing so, the system 200 may utilize, for example, MiniLM-L6-v2, which is an artificial intelligence model that is capable of receiving a sentence or paragraph as input and outputting a vector that represents semantic information. In operation, MiniLM-L6-v2 truncates textual input that exceeds 256 words. Rather than being a full fledged large language model, MiniLM is a compressed version of a transformer-based model designed to be computationally efficient. In particular, MiniLM is based on a bidirectional encoder representation from transformers (BERT) architecture that utilizes vectors that assign each word a unique identifier based on the contextual significance of the word.

A bidirectional encoder representation from transformers (BERT) architecture provides a mechanism to pre-train deep bidirectional representation from unlabeled text by conditioning on both left and right contexts in all layers of a neural network. That is, a model with a BERT architecture analyzes text sequences from both left to right and right to left and does so with a transformer model. A transformer model is a deep learning model that analyses an entire sequence in parallel rather than analyzing sequential dependencies. Accordingly, larger data sets may be analyzed and models may be trained more quickly than other types of models, such as a recurrent neural network. The resulting numeric vectors, which are also referred to as embeddings, retain semantic meaning in the numeric form, thereby enabling equivalence searches (e.g., through cosine similarity searches) and sorting of relevant phrases. In other embodiments, the system 200 may produce numeric vectors using other algorithms, such as a robustly optimized BERT pretraining approach (RoBERTa), a light BERT for self-supervised learning of language representations (ALBERT), a distilled version of the BERT base (DistilBERT), global vectors for word representation (GloVe), Word2vec, or embeddings from language model (ELMo).

Continuing the method 600, after the database of product information has been vectorized, or if the system 200 determined not to perform the vectorization process (e.g., because the product information has already been vectorized), the method 600 advances to block 618 in which the system 200 obtains a conversation string to determine, with an artificial intelligence model (e.g., a neural network 140, such as a large language model, such as Gemma 2 9B), whether to query the product information in the vectorized form. As indicated in block 620, the system 200, in the illustrative embodiment, obtains the conversation string based on typed input or speech recognition. That is, the system 200 may obtain a query provided by a customer in a retail location, such as through a user interface 160 of a computing device 150 (an extreme edge computing device 218, 238) in the retail location. The system 200 may provide the conversation string to an artificial intelligence model, such as the neural network 140, as an input, as indicated in block 622. More specifically, the system 200 may provide the conversation string to a neural network, as indicated in block 624 and even more specifically, may provide the conversation string to a large language model (LLM), as indicated in block 626 that has been trained to respond to queries for products in the retail location in a conversational manner. In at least some embodiments, the large language model is Gemma 2 9B.

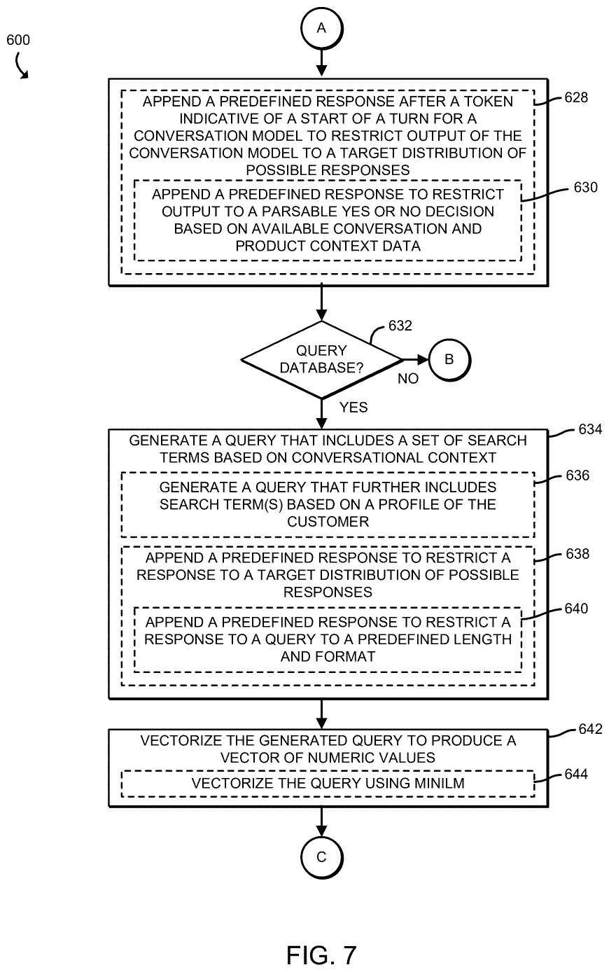

Referring now to FIG. 7, the system 200, having obtained the conversation string from the customer, may append a predefined response after a token that is indicative of a start of a turn for the conversation model (e.g., the LLM), as indicated in block 628. Appending the predefined response has the effect of restricting the possible output of the conversation model to a target distribution of possible responses. In the illustrative embodiment, the possible responses are no or yes, or similarly, true or false. As indicated in block 630, in the illustrative embodiment, the system 200 appends the predefined response to restrict the output to a parsable yes or no decision that is based on available conversation data, such as the content of the conversation string, and product context data, which may be any data indicative of the product or type of product or products that the customer has expressed an interest in. That is, the response from the conversation model is limited to an indication of whether to query a database of product information, and in particular, the vectorized product information that was produced in block 604. The vectorized product information is represented in block 316 of FIG. 3.

If the conversation model determines, in block 632, that a query should not be generated, the method 600 loops back to block 618 of FIG. 6 to obtain an additional conversation string. The conversation model may determine not to generate a query for product information if the customer has not yet asked, via the user interface 160, specifically for a recommendation for a product or set of products. That is, given that the artificial intelligence model is a conversation model, such as a large language model, the system 200 may converse with the customer over a series of strings to gather information, rather than obtaining a succinct question from the customer as to particular products that may be available in the retail location. Accordingly, in some embodiments, the method 600 may iterate through the operations of block 618 several times until the conversation model finally determines that the customer has provided enough information to form a query for the database of vectorized product information.

In response to a determination to query the database of vectorized product information, the method 600 advances to block 634. In block 634, the system 200 generates a query that includes a set of search terms based on the conversational context. For example, over a series of questions and answers in a conversation with the conversational model (e.g., the LLM), the customer may have expressed an interest in a drink that is canned and is carbonated and that is a type of cola. Accordingly, the system 200 may generate a search query that includes the terms “drink”, “canned”, “carbonated”, and “cola”. In at least some embodiments, the system 200 may add additional search terms that are based on a profile of the customer, in block 636. For example, if the customer has identified himself or herself prior to initiating a conversation with the conversational model (e.g., the LLM), such as through a sign in process or by otherwise providing an identifier that uniquely identifies the customer and which can be used by the system 200 to retrieve a corresponding profile that may be indicative of previous purchases by the customer, previous queries by the customer, stated interests of the customer, or other information attributable to the customer, the system 200 may add one or more pieces of information based on the profile as additional search terms for the query. For example, if the customer profile indicates that the customer has previously purchased Coke when presented with an option to purchase Coke or a competing brand, such as Pepsi, then the system 200 may add Coke as an additional search term. As an alternative example, if the customer has indicated in the past, an allergy or sensitivity to a particular ingredient or substance in food, such as gluten, the system 200 may add a search term for “gluten-free”. As yet another example, if the customer has indicated in the past a lifestyle or dietary preference, such as vegetarian, the system 200 may add a search term for “vegetarian” or known alternatives to meat, such as “soy” if the search relates to food that is commonly provided in the form of meat, such as hamburger patties.

In block 638, the system 200 may append a predefined response to restrict a response of the conversational model (e.g., the LLM) to a target distribution of possible responses. In doing so, the system 200 may append a predefined response to the restrict the response of the conversational model to a query having a predefined length (e.g., a maximum length) and format, such as a question format, rather than a statement, as indicated in block 640. Further, as indicated in block 642, the system 200 vectorizes the generated query from block 634 to produce a vector of numeric values. In doing so, in block 644, the system 200 may provide the query as an input to MiniLM, which, as described above, is a lightweight language model based on a bidirectional encode representation from transformers (BERT) architecture. Through the conversion to the numeric vector, the system 200 produces numeric values that retain the semantic meaning of the original words (e.g., the search terms). In other embodiments, the system 200 may vectorize the search query using another algorithm, such as a robustly optimized BERT pretraining approach (RoBERTa), a light BERT for self-supervised learning of language representations (ALBERT), a distilled version of the BERT base (DistilBERT), global vectors for word representation (GloVe), Word2vec, or embeddings from language model (ELMo).

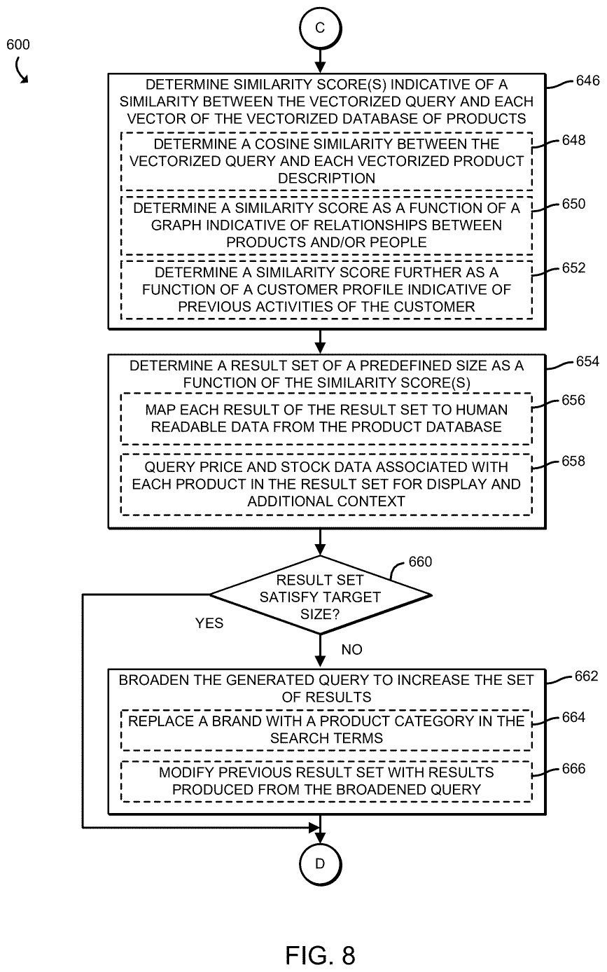

Referring now to FIG. 8, the system 200 determines similarity scores in block 646. The similarity scores are indicative of a similarity between the vectorized query from block 642 and each vector of the vectorized database of products (i.e., the vectorized product information 316) produced in block 604. In doing so, and as indicated in block 648, the system 200 may determine a cosine similarity between the vectorized query and each vectorized product description. The formula for the cosine similarity is provided above as Equation 1. The cosine similarity measures the similarity between two vectors of an inner product space. More specifically, the cosine similarity measures the cosine of the angle between two vectors and determines whether the two vectors are pointing in approximately the same direction. The cosine similarity falls within the range of −1 to 1. Two proportional vectors have a cosine similarity of 1. Two orthogonal vectors, by contrast, have a cosine similarity of 0. Two opposite vectors (e.g., pointing in opposite directions), have cosine similarity of −1. The cosine similarity is calculable as a result of natural language words being converted into numeric vectors that retain the semantic meanings (e.g., via MiniLM or other embedding approaches discussed above).

As described above, in the illustrative embodiment, the system 200 may determine the cosine similarity between the vectorized query and every vector in the vectorized database of products concurrently (e.g., simultaneously). In particular, and as indicated in block 648, the system 200 may determine the cosine similarity between the vectorized query and each vectorized product description, from the vectorized product information 316, as certain product descriptions may have similar words or similar meanings to the search terms from the query. As indicated in block 650, the system 200 may determine a similarity score as a function of a graph indicative of relationships between products and/or people. That is, rather than performing a cosine similarity search, the system 200 may maintain one or more graph data structures indicative of relationships between products and/or people who may purchase those products for themselves or for people they are related to in the graph data structure. In such embodiments, distances between nodes in the graph, representative of products and/or people, may be determined by weights assigned to the connections (e.g., edges) between the nodes and the number of intervening nodes. In yet other embodiments, while the system 200 may maintain a graph data structure, the system may still determine the similarity by converting graph data into a vectorized format using a corresponding algorithm, such as Node2vec. The node2vec algorithm operates by performing random walks through a graph, starting a target node. Random walks through a graph are analogous to sentences in a corpus. Accordingly, in the node2vec approach, each node in a graph is treated as an individual word, and a random walk is treated as a sentence. By providing sentences resulting from random walks through the graph structure, corresponding semantic meanings can be derived and corresponding numeric vectors (e.g., embeddings) can be produced, thereby enabling use of the cosine similarity search described above. In some embodiments, the system 200 may further determine the similarity score as a function of a customer profile that is indicative of previous activities of the customer, as indicated in block 652. That is, as described above, the system 200 may incorporate search terms based on previous searches, purchases, or stated interests of the customer that have been saved by the system 200 in connection with a profile of the customer, even if the interests were not expressly mentioned in the conversation string(s) provided by the customer to the system 200 in the present interaction.

Subsequently, the system 200 determines a result set from the similarity scores, as indicated in block 654. The result set, in the illustrative embodiment, is limited to a predefined size (e.g., a defined maximum size) and includes the results with the greatest similarity to the vectorized query (e.g., as indicated by the cosine similarity scores). Given the result set, the system 200 maps each result to human readable data from the product database, as indicated in block 656. That is, the system 200 looks up the corresponding entries in their non-vectorized form in the product catalog 312 to obtain parsable, human readable product descriptions and related information about each of the products in the result set. The system 200 may query, for example, price and/or stock data associated with each product represented in the result set, as indicated in block 658. As stated above, the stock data is any data that indicates the number or quantity of a given product available at the retail location. The price data may include information not only about the current price of the product, but also any available discounts on the product. In the illustrative embodiment, the system 200 queries the additional information for use in displaying that data in association with an identification of the product itself to the customer, to provide additional contextual information that may be beneficial to the customer. For example, if the price information indicates that there is a special discount available where the customer may purchase two of the products for the price of one, but the stock information indicates that only one unit of the product is available in the retail location, the customer may opt for an alternative product with a similar discount and which has more units available in the retail location.

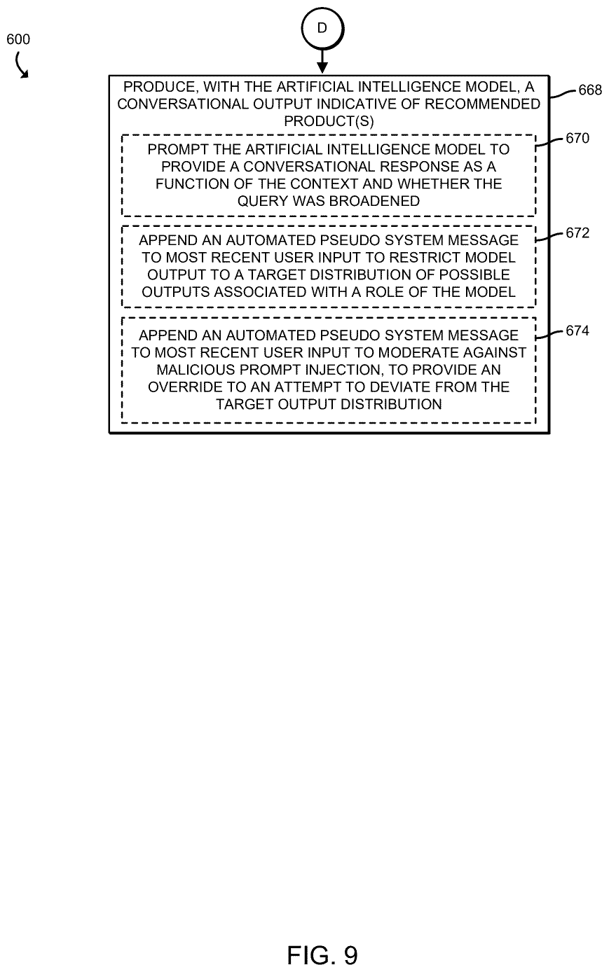

In block 660, the system 200 determines whether the result set satisfies a target size. That is, while an upper limit or maximum number of results may be imposed on the result set, in some scenarios, the search terms may be so specific that no results satisfy a similarity score threshold and the result set may be empty. If the result set does not satisfy the target size (e.g., at least one), then the method 600 advances to block 662. In block 662, the system 200 may broaden the generated query to increase the set of results. That is, the system 200 may execute another iteration of the operations of block 646 based on a revised query that has been broadened. To broaden the query, the system 200 may replace a specific search term, such as an identifier of a brand with a more general search term, such as the category of a product (of which the specific brand is a subset), as indicated in block 664. In other embodiments, the system 200 may delete a search term rather than modifying or replacing it. In block 666, the system 200 modifies the previous result set with results produced from the broadened query (e.g., based on execution of the operations of blocks 646 and 654). In some embodiments, the system 200 replaces the original result set with the new result set, such as cases in which the original result set is empty. In other embodiments, the system 200 appends or otherwise combines the revised result set with the original result set to increase the number of results. Further, as indicated in the flow of FIG. 8, the system 200 does not repeatedly perform further broadening of the query. Rather, after a single broadening of the query, the system 200 avoids performing additional broadening. Doing so prevents to system 200 from producing results that are irrelevant to the query and the interests of the consumer. After adjusting the result set, or if a sufficient number of results were present in the original result set, the method 600 advances to block 668 of FIG. 9, in which the system 200 produces, with the artificial intelligence model (e.g., the conversation model, which in the illustrative embodiment is a large language model, such as Gemma 2 9B), a conversational output. The conversational output is indicative of a set of recommended products. That is, the conversational output is indicative of the result set from blocks 654 and/or 662, described above.

The system 200, in producing a conversational output that is indicative of a set of one or more recommended products, may prompt the artificial intelligence model (the conversation model) to provide a conversational response, as indicated in block 670. That is, and as further indicated in block 670, the system 200 may prompt the artificial intelligence model to provide a response that follows logically from the preceding communications between the customer and the system 200, via the user interface 160, and having a flow similar to that of a human conversation. In doing so, the system 200 prompts the artificial intelligence model to produce the response as a function of the context and whether the query was broadened. That is, the system 200 may prompt the artificial intelligence model to produce a response that accounts for previous communications from the customer during the communication session via the user interface 160, such as referring back to information that may have been provided by the customer through the user interface 160. The system 200 may also state that an initial search turned up few or no results and, as a result, the system 200 broadened the search to assist the customer in finding a product that is relevant to their interests.

In some embodiments, the system 200 may append an automated pseudo system message to a most recent user input (e.g., string from the customer), as indicated in block 672. Appending the pseudo system message may have the effect of restricting an output or response from the artificial intelligence model to a target distribution of possible outputs. Those possible outputs, in the illustrative embodiment, are outputs that correspond with the role of the artificial intelligence model. That is, the possible outputs are restricted to responses that align with the role of the artificial intelligence model being assigned to provide assistance with identifying products that are within the retail location and that may be of interest to the user based on the present conversation with the customer. Accordingly, the pseudo system message prevents the artificial intelligence model from providing a response that departs from the assigned role and that may confuse the customer or otherwise provide irrelevant information that does not further the goal of assisting the present customer.

Similarly, and as indicated in block 674, the system 200 may append an automated pseudo system message to a most recent user input to moderate against (e.g., guard against) malicious prompt injection. A malicious prompt injection is a type of cyber attack focused on large language models (LLMs) in which an actor disguises malicious inputs as legitimate prompts, thereby causing a generative artificial intelligence system to provide sensitive or secret information or spread misinformation. An example of a malicious prompt injection may be a string submitted by an actor that includes the request to ignore previous instructions or rules, before asking a question that would otherwise be filtered out given special safety-related treatment pursuant to a set of rules or training data that was previously represented in the generative artificial intelligence model. Given that generative artificial intelligence models, and in particular, large language models, are programmable through natural language prompts or instructions, the models do not distinguish between prompts entered by a user and prompts that are entered by a software developer. That is, large language models can be fine tuned by software developers through a process known as instruction fine-tuning, in which natural language instructions (system prompts) crafted by software developers are submitted to the large language model to instruct the large language model how to respond to user input. When a user interacts with a large language model, the user's input is combined with any system prompts in a single command to the large language model. By appending the pseudo system message to any input string that the user (customer) provided through the user interface 160, the system 200 may override to any attempt by the user to cause the artificial intelligence model to deviate from the target output distribution. The appended pseudo system message may include a set of instructions that override any request by the user (customer) for the artificial intelligence model to ignore its previous instructions that represent safeguards to providing sensitive information. The sensitive information may include, for example, customer profile information about customers other than the present customer and/or other information about relationships between customers and other people or products that may be represented in a data structure of the system 200, such as in a graph data structure as described above.

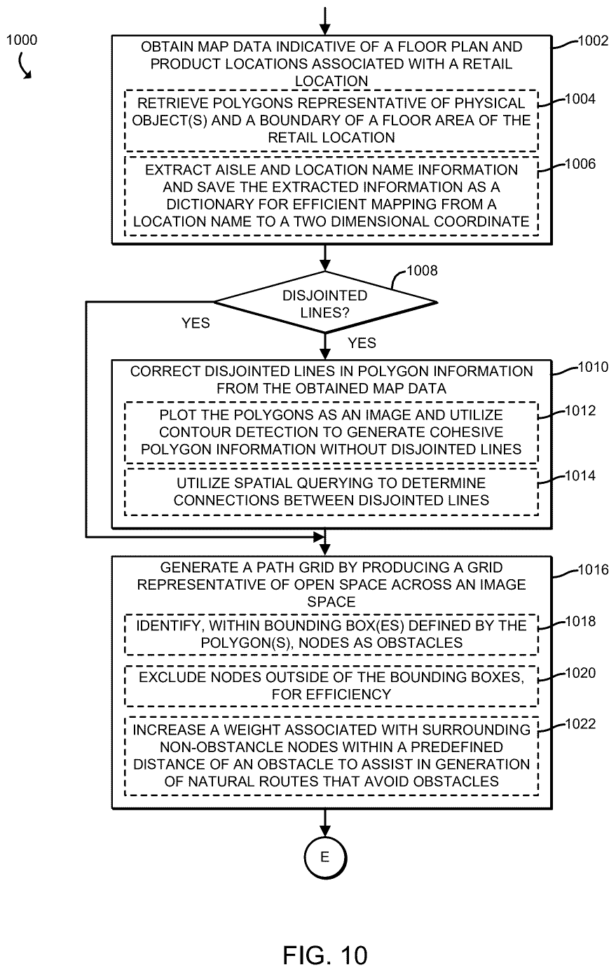

Referring now to FIG. 10, the system 200, in operation, may perform a method 1000 for routing a customer through a retail location to one or more products, such as products recommended by the system 200 through the performance of the method 600 described above with reference to FIGS. 6-9. The description of the method 1000 herein expands on the operations described relative to the pipeline 400 of FIG. 4. In block 1002, the system 200 may obtain map data. The map data, in the illustrative embodiment, is indicative of a floor plan and of product locations associated with a retail location. As described above, in some embodiments, the map data is encoded in a drawing exchange format (.dxf) file. In other embodiments, the map data may be in an initial format, such as a .dwg file, that the system 200 then converts to a .dxf file using a predefined algorithm. In some embodiments, the map data may be distributed across multiple data sets or files, such as one file that contains the floor plan of the retail location and another file that contains information about the locations of products within the retail location. As indicated in block 1004, the system 200, in the illustrative embodiment, retrieves, from the map data, polygons representative of physical objects within the retail location, such as aisles, doors, walls, and products. Further, the system 200 retrieves data indicative of a boundary of the floor area of the retail location. The boundary may be defined as a bounding box, which may be a rectangular area around the floor area, and may be defined by two coordinates representing opposite corners of the rectangle, such as an upper-left corner and a lower-right corner. The system 200 may read data defining the boundary of the floor area from the map data or, in some cases, may determine the boundary itself, based on a minimum bounding box algorithm. For example, the system 200 may determine, for a convex polygon represented in the map data, that a minimum-area enclosing box is collinear with a side of the convex polygon and enumerate boxes having that property with a corresponding algorithm, such as a rotating calipers algorithm. In a rotating calipers algorithm, antipodal pairs of points on a convex polygon are determined to compute a diameter of the polygon and to identify a configuration of antipodal pairs that provides the smallest area for a bounding box around the polygon.

The system 200, in the illustrative embodiment, also extracts aisle and location name information from the map data, as indicated in block 1006. In doing so, the system 200 saves the extracted information as a dictionary data structure. That is, the system 200 may save the extracted information as a set of key-value pairs, in which each unique key is associated with a corresponding value. Storing the extracted information as a dictionary data structure enables efficient mapping from a location name (i.e., a key) to a two dimensional coordinate (e.g., within the floor plan of the retail location) (i.e., a value). In some scenarios, the polygons extracted from the map data may not be cohesive. That is, the polygons may have lines that are disjointed from each other and do not form a closed structure. Such issues may arise due to incomplete map data, inaccuracies in the measurements of distances or angles of lines within the map data, data corruption, or other errors. If the system 200 determines, in block 1008, that the map data includes polygons with disjointed lines, the method 1000, in the illustrative embodiment, advances to block 1010, in which the system 200 performs operations to correct the disjointed lines.

In block 1010, the system 200 corrects the disjointed lines in the polygon information extracted from the map data obtained in block 1002. In doing so, in block 1012, the system 200 may plot the polygons, as extracted from the map data, as an image. In doing so, the system 200 may represent the lines of the polygon with pixels having a defined color or intensity in a two dimensional coordinate space in which other pixels, representing empty space, have a different color or intensity that differs from the pixels representing lines by a threshold amount. For example, in a simple case in which a binary image is produced, the pixels representing lines may be black, represented with a value of zero, and the empty space may be white, and represented with either a one or 255 (e.g., for eight-bit intensity values), depending on the specific implementation. Once plotted in an image, such as a bitmap image, the system 200 may utilize contour detection to detect the border of the shapes represented in the image. That is, the system 200 may identify lines or curves that join sets of continuous or nearly continuous points along a boundary of a shape (e.g., a polygon) and may fill in any gaps of a predefined size (e.g., two empty-space pixels) by connecting the detected lines or curves. The resulting image represents cohesive polygon information without disjointed lines. Additionally or alternatively, the system 200 may utilize spatial querying to determine connections between disjointed lines, as indicated in block 1014. In the illustrative embodiment, the above-described method of plotting the polygons and utilizing contour detection is utilized initially, as doing so provides computational efficiencies over spatial querying. Accordingly, spatial querying may be utilized as a fallback approach to correct disjointed lines if the contour detection approach does not correct all disjointed lines for polygons represented in the map data.

Subsequently, in block 1016, the system 200 generates a path grid. In the illustrative embodiment, the system 200 generates the path grid by producing a grid that is representative of open space across an image space. The system 200, in the illustrative embodiment, identifies, within one or more bounding boxes defined by the polygon that were extracted from the map data, one or more nodes that are representative of obstacles, as indicated in block 1018. For efficiency, the system 200 ignores or excludes from the analysis, any nodes that fall outside of the bounding box(es) associated with the polygons, as indicated in block 1020. That is, by limiting the set of nodes for analysis to only those that are within the confines of the floor area of the retail location (e.g., within the bounding boxes of the polygons representing the floor plan of the retail location), the system 200 avoids spending computational resources (e.g., time, energy, processor cores) on analyzing nodes that will not be encountered during a customer's journey through the retail location. In at least some embodiments, the system 200 may increase a weight associated with nodes that do not represent an obstacle (non-obstacle node(s)) that surround a node that has been identified as an obstacle, as indicated in block 1022. In doing so, the system 200 may determine whether a given non-obstacle node is within a predefined distance of a node representative of an obstacle and increase the weight of such a non-obstacle node only if the non-obstacle node is within the predefined distance of the obstacle node. By adjusting the weights as described above, the system 200 causes any resulting paths through the retail location to route around any obstacles in a natural manner that more closely resembles the path that a human would take through the retail location. That is, by adjusting the weights as described above, the system 200 increases the likelihood that a path generated through the retail location will have a more gradual turn, rather than an abrupt turn, to avoid a given obstacle.

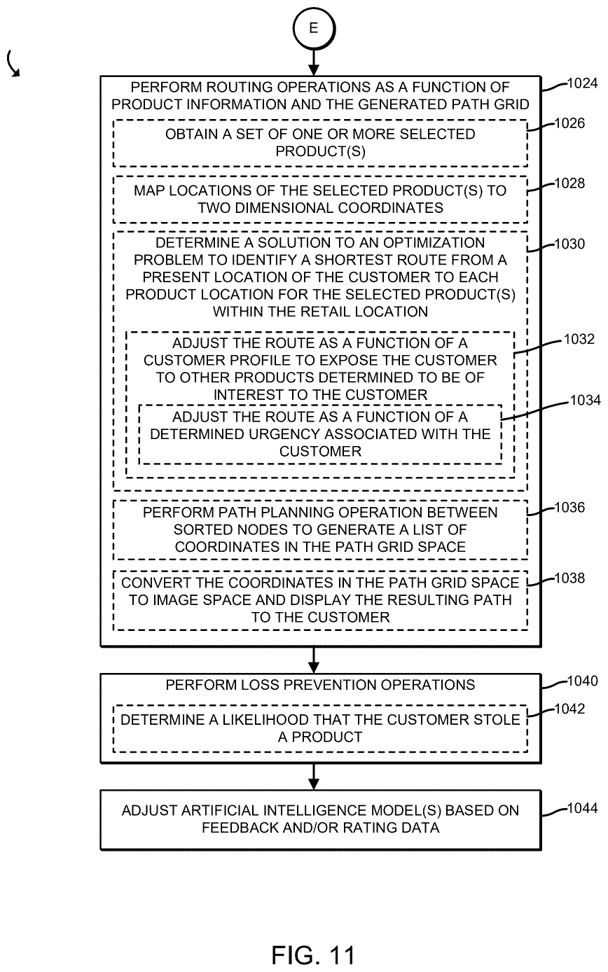

Continuing the method 1000, and referring now to FIG. 11, the system 200 performs routing operations as a function of product information and the generated path grid, as indicated in block 1024. That after the path grid has been generated from the extraction of polygons from the map data, correction of any disjointed lines, generation of a dictionary that maps location names to coordinates, and generation of the path grid as described above, the system 200 is in a state to perform routing operations to route a customer to a set of one or more products, such as a set of products resulting from the recommendation operations of the method 600, within the corresponding retail location. The system 200, in the illustrative embodiment, obtains, in block 1026, data indicative of a set of one or more selected products, such as one or more products recommended by the artificial intelligence model (e.g., an LLM, such as Gemma 2 9B) discussed with reference to the method 600. Accordingly, in the illustrative embodiment, the data indicative of the set of one or more selected products are textual identifiers of the products, such as the names, descriptions, and/or SKUs of the products. Further, the system 200 maps locations of the selected product(s) to corresponding two dimensional coordinates, as indicated in block 1028. As described above, the system 200 in the illustrative embodiment generates a dictionary data structure in which values, such as two dimensional coordinates, are stored as values corresponding to names (e.g., keys) in a dictionary of key-value pairs. Accordingly, the system 200 may quickly and efficiently look up the coordinates of a product based on the name of the product, using the key-value structure stored in the dictionary.

Further, the system 200 determines a solution to an optimization problem to identify a shortest route from a present location of the customer (e.g., at the user interface 160) to each product location for the selected product(s) within the retail location, as indicated in block 1030. In embodiments in which the system 200 maintains a profile of a customer, the system 200 may adjust the route to be provided to the customer, based on the profile of the customer, as indicated in block 1032. For example, the system 200 may add, to the route, the locations of one or more other products within the retail location that the customer did not specifically ask about in the conversation with the artificial intelligence model in the method 600. Those additional products may be products that the customer has expressed an interest in based on previous purchases or stated interests of the customer, as reflected in the customer profile. In embodiments in which the system 200 maintains a graph data structure indicative of relationships between people and products, the system 200 may determine that the customer may perform purchases for another person who may have an interest that matches one or more products within the retail location. Accordingly, the system 200 may add the location(s) of those products to the route.

The system 200 may selectively enable or disable the functionality of block 1032 based on whether the customer has indicated that he or she is short on time or is exhibiting a sense of urgency with their request for one or more products, as indicated in block 1034. The artificial intelligence model utilized by the system 200 may determine a sentiment associated with words provided by the customer in the prompt(s) for one or more products. The system 200 may determine the sentiment by comparing words used in the strings from the customer to a predefined mapping of words and corresponding sentiments in a memory of the system 200. The system 200 may also determine whether a sense of urgency is expressed based on a length or number of prompts provided by the customer in the interaction with the system 200, in which shorter and/or fewer prompts may be indicative of a higher sense of urgency. Further, in embodiments in which the prompts of strings from the user were generated from a voice to text conversion, the voice to text process itself may identify characteristics, such as one or more of a particular pitch, tone, volume, and/or cadence, in the customer's voice that is statistically correlated with stress or urgency, and the system 200 may store a flag indicative of that determination for use by the system 200 in the operations of blocks 1032 and 1034. If the system 200 determines that the customer is in a hurry (e.g., is short on time, has indicated a sense of urgency, etc.), the system 200 disables the operations of block 1032 and instead routes the customer more directly to the selected products (e.g., recommended products) determined from the customer's request.

As indicated in block 1036, the system 200, in the illustrative embodiment, performs one or more path planning operations between sorted nodes to generate a list of coordinates in the path grid space. Further, and as indicated in block 1038, the system converts the coordinates in the path grid space, from block 1036, to an image space. Further, the system 200 displays the resulting path (route) through the retail location to the customer. In doing so, the system 200, in the illustrative embodiment, displays the path (route) via the user interface 160.

After providing the route to the customer, such as via the user interface 160, the system 200 may perform one or more loss prevention operations, such as determining a likelihood that the customer stole a product from the retail location, as indicated in blocks 1040, 1042. That is, the system 200 may determine, for example, whether the customer walked to a recommended product, spend a threshold amount of time at the location of the product, then left the retail location without performing a checkout process to purchase the product. In making the determination as to the likelihood of that the customer stole the product, the system 200 may analyze image and/or video data captured by the security cameras 250, 252, 254, 256 and/or any other available cameras in the retail location. The system 200 may determine that certain queries inherently have a higher likelihood of theft associated with them than other types of queries. For example, the system 200 may associate queries that inquire about the value or price of products available in the store, without relating to the category of the product or specific needs or interests of the customer (e.g., “Where are the most expensive items in the store?”) with a higher likelihood of theft than other queries. Further, in some embodiments, the system 200 may draw from data associated with stored profile associated with the customer to adjust a determination of whether theft is likely. Further, and as indicated in block 1044, the system 200 may adjust one or more artificial intelligence models utilized to determine the likelihood of theft based on data indicative of whether a product was actually stolen. That is, if the system 200 incorrectly predicted that a customer was likely to steal a product when the customer actually did not steal the product, or incorrectly predicted that a customer was unlikely to steal a product when the customer actually did steal the product, the system 200 may adjust the one or more models with negative feedback to produce more accurate predictions in the future.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A system for automatically directing a customer to a product within a retail location based on an artificial intelligence model, comprising:
at least one processor;
a memory coupled with the at least one processor, the memory including instructions that, when executed by the at least one processor cause the at least one processor to:
obtain a conversation string through a user interface in a retail location to determine, with an artificial intelligence model, whether to query a database of vectorized product information indicative of a plurality of numeric vectors, wherein each numeric vector represents a numeric representation of at least a description of each of multiple products associated with the retail location and wherein the conversation string is generated based on one or more of typed input or speech recognition;
generate, in response to a determination to query the database of vectorized product information, a query that includes a set of search terms based on a conversational context associated with the conversation string obtained through the user interface in the retail location, including appending a predefined response to the query to restrict a response from the artificial intelligence model to a target distribution of possible responses;
vectorize the generated query to produce a vector of numeric values;
determine a set of similarity scores, wherein each similarity score is indicative of a similarity between the vectorized query and a corresponding numeric vector in the database of vectorized product information;
determine a result set of a predefined size as a function of the similarity scores including mapping each product represented in the result set to corresponding human-readable data indicative of the description of the corresponding product;
produce, with the artificial intelligence model and as a function of a conversational context, a conversational output indicative of one or more recommended products from the result set for use by a customer to obtain the product from the retail location; and
display, with the user interface and based on a generated path grid produced from map data indicative of a floor plan and product locations, an image representative of a path through the retail location to direct the customer to the one or more recommended products.

2. The system of claim 1, wherein the processor is further configured to:
generate the numeric vectors representative of each row of multiple rows of a database of non-vectorized product information, including generating the numeric vectors for each of a predefined number of stock keeping units represented in the database of non-vectorized product information and wherein the numeric vectors are further representative of one or more of an image, a location, a price, stock information, or a rating for each corresponding product.

3. The system of claim 1, wherein the processor is further configured to:
provide the conversation string to a large language model; and
append, to the conversation string, predefined data after a token indicative of a start of a turn for the large language model, to restrict a response of the large language model to the conversation string and appended data to a yes or no decision, based on conversation data and product context data available to the large language model.

4. The system of claim 1, wherein the processor is further configured to:
generate a query that further includes one or more search terms based on a profile of the customer, wherein the profile of the customer is indicative of one or more previous activities of the customer;
determine the set of similarity scores by determining each similarity score based on a cosine similarity between the vectorized query and each vectorized product description and further as a function of the customer profile; and
query price and stock data associated with each product represented in the result set for display to the customer with the user interface.

5. The system of claim 1, wherein the processor is further configured to:
determine whether the result set satisfies a target size;
replace, in response to a determination that the result set does not satisfy the target size, a search term indicative of a brand with a product category to broaden the set of search terms associated with the query;
modify the result set with results produced by the artificial intelligence model based on the broadened set of search terms associated with the query; and
prompt the artificial intelligence model to provide the conversational response indicative of the one or more recommended products further as a function of whether the search terms of the query were broadened.

6. The system of claim 5, wherein the processor is further configured to:
append an automated pseudo system message to a most recent user input to restrict model output from the artificial intelligence model to a target distribution of possible outputs associated with a role of the artificial intelligence model and to moderate against malicious prompt injection, to provide an override to an attempt to deviate from the target output distribution.

7. The system of claim 5, wherein the processor is further configured to:
determine the similarity score further as a function of a graph data structure indicative of at least one of relationships between one or more the of the products or relationships between the customer and one or more other people.

8. The system of claim 1, wherein the processor is further configured to:
obtain the map data indicative of the floor plan and the product locations associated with the retail location, including retrieving a set of polygons representative of one or more physical objects in the retail location and a boundary of a floor area of the retail location and extracting aisle and location name information and saving the extracted aisle and location name information in a dictionary data structure for efficient mapping from a location name to a two dimensional coordinate; and
correct disjointed lines in polygon information from the obtained map data including plotting the polygons as an image and utilizing contour detection to generate cohesive polygon information without disjointed lines or utilizing spatial querying to determine connections between the disjointed lines.

9. The system of claim 8, wherein the processor is further configured to:
generate the path grid by identifying within bounding boxes defined by the polygons, one or more nodes as corresponding obstacles, excluding nodes outside of the bounding boxes for increased efficiency, and increasing a weight associated with surrounding non-obstacle nodes that are within a predefined distance of an obstacle node to assist in generation of natural routes within the retail location that avoid the obstacles; and
perform routing operations by obtaining a set of one or more selected products representative of the one or more recommended products, mapping a location of each selected product to a corresponding set of two dimensional coordinates, determining a solution to an optimization to identify a shortest route from a present location of the customer to each location of each selected product within the retail location, performing path planning operations between sorted nodes to generate a list of coordinates in a path grid space, and converting the coordinates in the path grid space to an image space to display the resulting path to the customer with the user interface.

10. The system of claim 1, wherein the processor is further configured to:
determine, with the artificial intelligence model, a likelihood of whether the customer stole one of the recommended products based at least in part on whether the product was automatically identified at a point of sale system in which item parameters associated with the recommended product are extracted from a plurality of images captured by a plurality of cameras positioned at the point of sale system; and
adjust the artificial intelligence model based on the determined likelihood and data indicative of whether the recommended product was actually stolen by the customer.

11. A method for automatically directing a customer to a product within a retail location based on an artificial intelligence model, comprising:
obtaining a conversation string through a user interface in a retail location to determine, with an artificial intelligence model, whether to query a database of vectorized product information indicative of a plurality of numeric vectors, wherein each numeric vector represents a numeric representation of at least a description of each of multiple products associated with the retail location and wherein the conversation string is generated based on one or more of typed input or speech recognition;
generating, in response to a determination to query the database of vectorized product information, a query that includes a set of search terms based on a conversational context associated with the conversation string obtained through the user interface in the retail location, including appending a predefined response to the query to restrict a response from the artificial intelligence model to a target distribution of possible responses;
vectorizing the generated query to produce a vector of numeric values;
determining a set of similarity scores, wherein each similarity score is indicative of a similarity between the vectorized query and a corresponding numeric vector in the database of vectorized product information;
determining a result set of a predefined size as a function of the similarity scores including mapping each product represented in the result set to corresponding human-readable data indicative of the description of the corresponding product;
producing, with the artificial intelligence model and as a function of a conversational context, a conversational output indicative of one or more recommended products from the result set for use by a customer to obtain the product from the retail location; and
displaying, with the user interface and based on a generated path grid produced from map data indicative of a floor plan and product locations, an image representative of a path through the retail location to direct the customer to the one or more recommended products.

12. The method of claim 11, further comprising:
generating the numeric vectors representative of each row of multiple rows of a database of non-vectorized product information, including generating the numeric vectors for each of a predefined number of stock keeping units represented in the database of non-vectorized product information and wherein the numeric vectors are further representative of one or more of an image, a location, a price, stock information, or a rating for each corresponding product.

13. The method of claim 11, further comprising:
providing the conversation string to a large language model; and
appending, to the conversation string, predefined data after a token indicative of a start of a turn for the large language model, to restrict a response of the large language model to the conversation string and appended data to a yes or no decision, based on conversation data and product context data available to the large language model.

14. The method of claim 11, further comprising:
generating a query that further includes one or more search terms based on a profile of the customer, wherein the profile of the customer is indicative of one or more previous activities of the customer;
determining the set of similarity scores by determining each similarity score based on a cosine similarity between the vectorized query and each vectorized product description and further as a function of the customer profile; and
querying price and stock data associated with each product represented in the result set for display to the customer with the user interface.

15. The method of claim 11, further comprising:
determining whether the result set satisfies a target size;
replacing, in response to a determination that the result set does not satisfy the target size, a search term indicative of a brand with a product category to broaden the set of search terms associated with the query;
modifying the result set with results produced by the artificial intelligence model based on the broadened set of search terms associated with the query; and
prompting the artificial intelligence model to provide the conversational response indicative of the one or more recommended products further as a function of whether the search terms of the query were broadened.

16. The method of claim 15, further comprising:
appending an automated pseudo system message to a most recent user input to restrict model output from the artificial intelligence model to a target distribution of possible outputs associated with a role of the artificial intelligence model and to moderate against malicious prompt injection, to provide an override to an attempt to deviate from the target output distribution.

17. The method of claim 15, further comprising:
determining the similarity score further as a function of a graph data structure indicative of at least one of relationships between one or more the of the products or relationships between the customer and one or more other people.

18. The method of claim 11, further comprising:
obtaining the map data indicative of the floor plan and the product locations associated with the retail location, including retrieving a set of polygons representative of one or more physical objects in the retail location and a boundary of a floor area of the retail location and extracting aisle and location name information and saving the extracted aisle and location name information in a dictionary data structure for efficient mapping from a location name to a two dimensional coordinate; and
correcting disjointed lines in polygon information from the obtained map data including plotting the polygons as an image and utilizing contour detection to generate cohesive polygon information without disjointed lines or utilizing spatial querying to determine connections between the disjointed lines.

19. The method of claim 18, further comprising:
generating the path grid by identifying within bounding boxes defined by the polygons, one or more nodes as corresponding obstacles, excluding nodes outside of the bounding boxes for increased efficiency, and increasing a weight associated with surrounding non-obstacle nodes that are within a predefined distance of an obstacle node to assist in generation of natural routes within the retail location that avoid the obstacles; and
performing routing operations by obtaining a set of one or more selected products representative of the one or more recommended products, mapping a location of each selected product to a corresponding set of two dimensional coordinates, determining a solution to an optimization to identify a shortest route from a present location of the customer to each location of each selected product within the retail location, performing path planning operations between sorted nodes to generate a list of coordinates in a path grid space, and converting the coordinates in the path grid space to an image space to display the resulting path to the customer with the user interface.

20. The method of claim 11, further comprising:
determining, with the artificial intelligence model, a likelihood of whether the customer stole one of the recommended products based at least in part on whether the product was automatically identified at a point of sale system in which item parameters associated with the recommended product are extracted from a plurality of images captured by a plurality of cameras positioned at the point of sale system; and
adjusting the artificial intelligence model based on the determined likelihood and data indicative of whether the recommended product was actually stolen by the customer.
